(19) United States
(12) Patent Application Publication
(10) Pub. No.: US 2013/0297692 A1
(43) Pub. Date: Nov. 7, 2013

(54) SOCIAL FAMILY NETWORKING PLATFORM

(71) Applicants: Reza RAJI, Menlo Park, CA (US); Gerry GUTT, Menlo Park, CA (US); David SWENSON, Menlo Park, CA (US)

(72) Inventors: Reza RAJI, Menlo Park, CA (US); Gerry GUTT, Menlo Park, CA (US); David SWENSON, Menlo Park, CA (US)

(21) Appl. No.: 13/750,867

(22) Filed: Jan. 25, 2013

Related U.S. Application Data
(60) Provisional application No. 61/590,674, filed on Jan. 25, 2012.

(51) Int. Cl. H04L 29/06

(52) U.S. Cl. CPC H04L 65/403
USPC 709/204

(57) ABSTRACT

Embodiments provide a database that includes family models. Each family model includes family data that is aggregated data of members of a family. The family data includes for each family member data of at least one of name, age, gender, education, interests, and memberships. Each family model comprises information that defines relationships between other families based on the family data. A platform includes a processor networked to the database and a social application executing on the processor. The platform, in response to a request to create the family model, collects the family data and generates the family model to include the family data. The platform enables the families to manage and interact using a collection of group types.

### RELATED APPLICATION

This application claims the benefit of U.S. Patent Application No. 61/590,674, filed Jan. 25, 2012.

### TECHNICAL FIELD

The embodiments described herein relate generally to a method and apparatus for social networking and, more particularly, the embodiments described herein relate to a social family networking.

### BACKGROUND

Conventional social networks such as Facebook, Google+ and Twitter, are person-based. As such, these conventional social networks operate on the basis of the individual's identity being at the center of the social interaction. The individual, through their account, can meet new people, invite them as friends, “follow” them, share (post, message) interesting information about themselves and read about their friends' activities and interests, among other things.

Conventional social networks also do not elegantly handle auto-expire groups. Once a person has been accepted as a “friend,” they remain a friend permanently until they are explicitly removed as a friend (an uncommon occurrence.) The concepts of “groups” and lists have been introduced over time by such traditional social networks but they serve only as a rudimentary communication distribution list and not as a many-to-many network with the associated social intelligence and analytics.

While the conventional social networks represent a fun and useful service for many, they simply do not address the needs of a family when it comes to meeting other interesting families, managing the complex and dynamic circles of families they interact with, sharing relevant family information and recommendations and simply connecting in real-time with the close circle of families they care about the most.

In summary, the conventional social networks are limited in that they cannot support families as the core unit of social networking, and cannot support the dynamic and complex set of circles the typical family is actively engaged with at any point in time such as permanent, auto-expire and affiliated groups. Further, the only support provided by conventional social networks to groups and/or lists uses a limited method of many-to-one communication and does not provide true many-to-many networking amongst families.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of the SocialParent system, under an embodiment.

FIG. 2 shows the interactions provided by SocialParent, under an embodiment.

FIG. 3 shows a flow diagram of the “add” model of SocialParent, under an embodiment, along with flow diagrams for several social networks that employ different types of “invite” models.

FIG. 4 is a status badge legend, under an embodiment.

FIG. 5 is a tour presented by the social family networking application to the user prior to user creation of account, under an embodiment.

FIG. 6 is a set of screens presented to the user during user creation of an account with the SocialParent network, under an embodiment.

FIG. 7 is a set of screens showing a user logging into the SocialParent system, under an embodiment.

FIG. 8A is a set of screens showing a user feed, under an embodiment.

FIG. 8B is a set of screens showing a user feed, under an embodiment.

FIG. 8C is a set of screens showing a user feed, under an embodiment.

FIG. 8D is a set of screens showing a user feed, under an embodiment.

FIG. 8E is a set of screens showing a user feed, under an embodiment.

FIG. 9A is a set of screens showing user addition of families, under an embodiment.

FIG. 9B is a set of screens showing user addition of families, under an embodiment.

FIG. 10 is a set of screens showing user privacy level configuration, under an embodiment.

FIG. 11 is a set of screen shots showing a user adding a member to family, under an embodiment.

FIG. 12A is a set of screen shots showing a user managing groups, under an embodiment.

FIG. 12B is a set of screen shots showing a user managing groups, under an embodiment.

FIG. 13 is a set of screen shots showing radar functionality of the SocialParent system, under an embodiment.

FIG. 14 is a set of screen shots showing radar functionality of the SocialParent system, under an embodiment.

FIG. 15 is a set of screen shots showing user creating and editing of plans, under an embodiment.

FIG. 16 is a set of screen shots showing use and functionality of application messaging, under an embodiment.

FIG. 17 is a set of screen shots showing a settings interface of the social family networking application, under an embodiment.

FIG. 18 is an application screen showing tour concept presented to user prior to user creation of an account, under an embodiment.

FIG. 19 is an application screen showing tour concept presented to user prior to user creation of an account, under an embodiment.

FIG. 20 is an application screen showing tour concept presented to user prior to user creation of an account, under an embodiment.

FIG. 21 is an initial application screen after registration, under an embodiment.

FIG. 22 is an initial application screen after registration, under an embodiment.

FIG. 23 is a welcome screen welcoming user to SocialParent, under an embodiment.

FIG. 24 is a slide out menu of a welcome screen, under an embodiment.

FIG. 25 is a populated feed screen, under an embodiment.

FIG. 26 is an application screen showing a conversation, under an embodiment.

FIG. 27 is application screen showing a conversation including ignore family function, under an embodiment.

FIG. 28 is a populated feed screen, under an embodiment.

FIG. 29 shows action buttons, under an embodiment.

FIG. 30 shows an our circle screen providing user add button for adding families, under an embodiment.

FIG. 31 shows scrolled down portion of an our circle screen showing ignored families menu item, under an embodiment.

FIG. 32 shows an add family screen, under an embodiment

FIG. 33 shows an add family via contacts screen, under an embodiment.

FIG. 34 shows an add family via groups screen, under an embodiment.

FIG. 35 shows privacy level, under an embodiment.

FIG. 36 shows privacy level, under an embodiment.

FIG. 37 shows privacy level, under an embodiment.

FIG. 38 shows an add member screen, under an embodiment.

FIG. 39 shows an application screen enabling user to create or join groups to interact with family secondary circles, under an embodiment.

FIG. 40 shows a screen enabling user to input group name and data, under an embodiment.

FIG. 41 shows a screen enabling user to post messages, under an embodiment.

FIG. 42 is a screen demonstrating radar functionality of the SocialParent system, under an embodiment.

FIG. 43 shows an application screen showing radar filters, under an embodiment.

FIG. 44 is an application screen showing plans including families invited and enabling addition of plans.

FIG. 45 shows a families invited screen, under an embodiment.

FIG. 46 shows an accepted invite view, under an embodiment.

FIG. 47 is an application view listing messages, under an embodiment.

### DETAILED DESCRIPTION

Embodiments described herein provide systems and methods for social family networking that treat families (including parents, kids, pets) as a core unit of social interaction and intelligently manage permanent and auto-expire groups. Through intelligent social analytics and application of social features such as “friending”, “liking” and recommendations, the SocialParent platform described herein enables families to connect and share much easier with a significant increase in “serendipitous” family connections and communication. The SocialParent platform or system is also referred to herein as “SocialParent”, the “platform”, and the “system.”

Parenting is, by nature, a heavily social task. A family interacts with other families in multiple, parallel, and ever changing fashion. A typical family is involved and routinely interacts with many types of groups, including but not limited to the following: the kids' school or daycare classrooms' families; the kids' sports league teams' (e.g., soccer, baseball, etc.) families; faith-based groups (e.g., church, congregation, etc.); other close families that are invited to join their circle of trust over time; a mom's group that the mother of the family has been associated with; other affiliations such as golf or country clubs, professional organizations, hobby groups, etc. Managing these family circles is a daunting task for parents, especially given the complex inter-dynamics of these circles as well as their constant state of flux. Applying the fundamental concepts of social networking to such a task has not been done prior to SocialParent described herein.

The family unit defines a real time “living” phenomenon and represents a demographic unit based on the aggregated data of multiple participating members. Discrete family units interact with one another in ways that individuals do not. In fact, the attributes of the family entity drive interactions that may override individual inclinations.

As one example, multiple families may have children in the same 2^{nd} grade class. Two children of this class may represent the “only child” of their respective households. The two sets of parents may therefore interact despite disparate religious, social and political beliefs out of an interest in those issues an only child may face versus a child with siblings. In this example, a family unit attribute, i.e. family with single child, becomes a proxy for a larger social network. Classroom demographic configurations (including classmates from families of all female/male siblings, classmates with twin siblings and classmates who play multiple sports) may produce an endless array of social interactions between corresponding parental units and therefore an endless array of social networks among them.

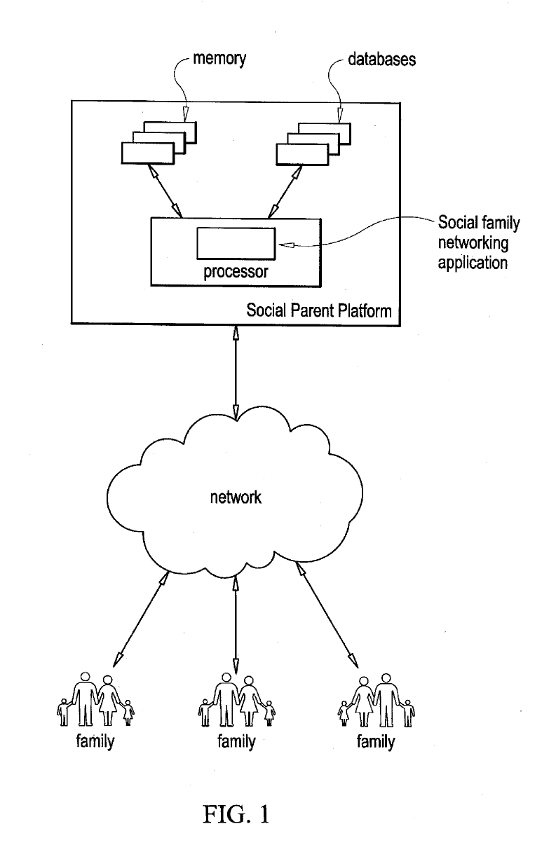

FIG. 1 is a block diagram of the SocialParent system, under an embodiment. The system comprises a platform including at least one processor coupled to one or more memory devices or databases. A social family networking component or application executes on the processor and provides the interactions described in detail herein.

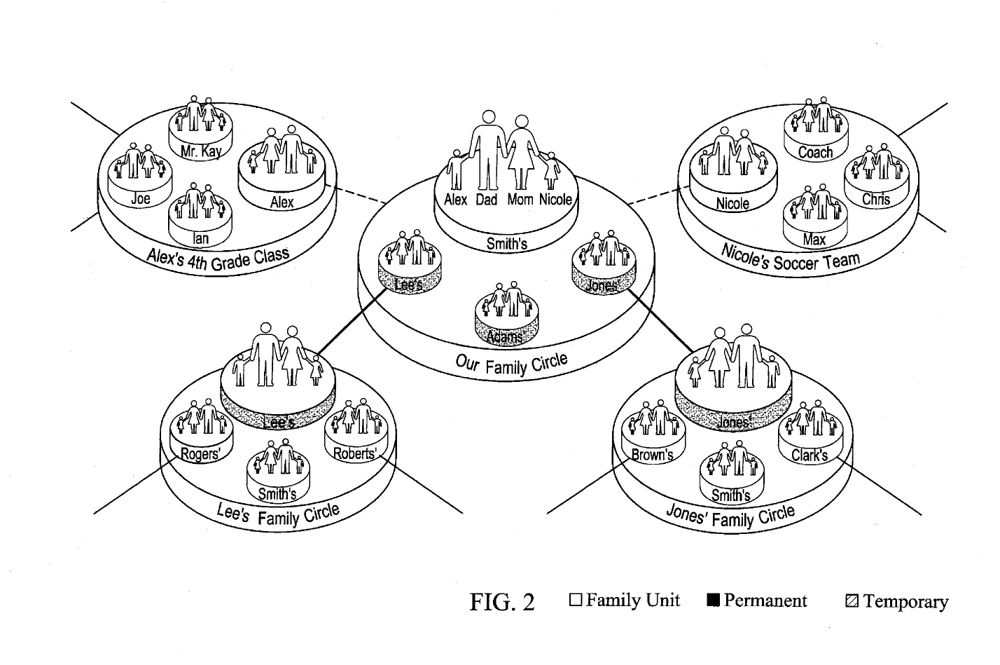

FIG. 2 shows the interactions of provided by SocialParent, under an embodiment. The social family networking platform described herein, and referred to herein as the SocialParent or SocialParent network, identifies the complexity of the family unit and uses new social networking tools/groups to manage interactions between such groups. Creating a family identity is the first step in generating and participating in a family social network. The network initially establishes the core family identity by collecting key family unit data/information including but not limited to the following: parents' names, birthdates, email, gender, address, etc.; children's names, birthdates, gender, interests (e.g., reading, math, soccer, piano, etc.), challenges (e.g., doesn't like reading or sports, etc.), and socially-relevant medical information (e.g., peanut allergy, asthma, etc.)

Once a significant number of families join the SocialParent network, a relevant social graph is formed that can serve to the benefit of all families involved. By connecting into and participating with this live family social network, the parents of each family can manage and interact (share updates, plans, recommendations, advice) with permanent, auto-expire and affiliated groups or circles, easily plan activities with other families as part of a conversation thread, and receive highly focused, custom-tailored recommendations (based on information including family members' age, gender, location, and interests/challenges) from one or more of their trusted network and an auto-curating social engine.

In describing the management and interaction (share updates, plans, recommendations, advice) provided by the permanent, auto-expire and affiliated groups or circles of SocialParent, permanent circles are a fully trusted group of families they routinely interact with as a family. This generally includes the families with a common collective set of interests and other attributes (including kid's ages and location). SocialParent includes a unique invite/add model described herein for these permanent groups that are uniquely matched to the requirements of families.

Auto-expire circle examples include the kids' classroom and soccer team families. These auto-expire groups are typically formed by a group organizer/administrator (e.g., teacher, coach, manager) but embodiments are not so limited. Such groups are dissolved after a certain period of time (e.g., 9 months for an elementary school class).

Affiliated groups comprise those that are permanent but the family does not necessarily want to include each member of that group as part of their circle of trusted families. A family's social connection with an affiliated group is a looser one than those of a permanent or auto-expire groups. Examples of family affiliated groups include faith based groups (church or congregation), country club membership, and professional organizations.

SocialParent also enables a family to at any time create their own custom circles for better further management of their family interactions. Examples of custom circles include Bowling buddies circle and daycare friends. These private circles are non-public and only exposed to the user. They are also common in social networks such as Facebook or Google+ (albeit at the individual, not family, level.).

SocialParent also enables a user to easily plan activities with other families as part of a conversation thread. Traditionally, plans are made through the use of some sort of calendaring (e.g., Outlook) or invitation tool (e.g., Evite). SocialParent's research has shown that families make many plans and most often those plans originated as a conversation between two or more people. SocialParent enables a user to turn a conversation thread into a plan by selecting the Plan button associated with that conversation thread, which causes the participants of the thread to be pulled into the invitation. The user then only has to add the time of the event along with other optional parameters (e.g., location) before hitting send, which sends the invitation out to all the invitees. The plan owner can also invite additional invitees at any time. The conversation thread around that plan is also imported and/or associated with that plan at the time the user hits the Plan button on the thread.

SocialParent enables users to receive highly focused, custom-tailored recommendations (based on information including family members' age, gender, location, and interests/challenges, for example) from one or more of their trusted network and an auto-curating social engine. Such recommendations can include but are not limited to the following: fun activities, books, music, toys, restaurant, and travel. This capability is derived from having a many-to-many family social graph where a family's collective interests and other attributes are correlated with other families' and intelligent recommendation and “serendipity” can be extracted.

A key feature of social family networking involves leveraging data extracted from many-to many network structure. The many-to-many network structure opens up data mining possibilities above and beyond one-to-one and many-to-one structures.

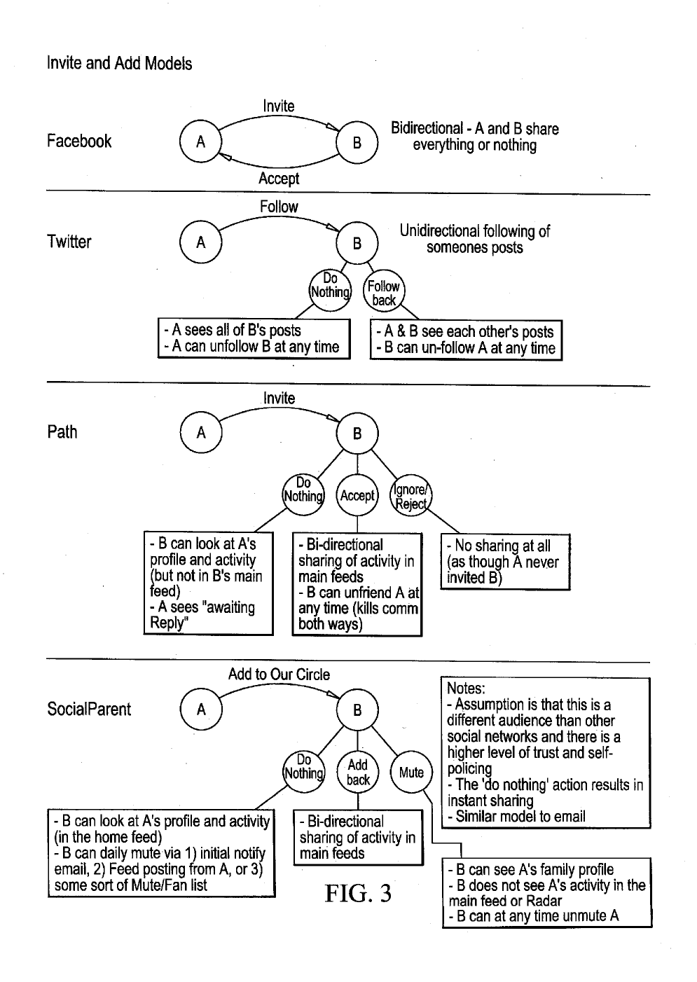

In recruiting for the SocialParent permanent circle, FIG. 3 shows a flow diagram of the “add” model of SocialParent, under an embodiment, along with flow diagrams for several social networks that employ different types of “invite” models. These social networks are described below.

One example of a conventional social network model is the All-or-nothing Bi-directional Invite model which is used, for example, by Facebook. A user (A) explicitly invites another user (B) and only if user B accepts are the two users fully connected and sharing information. Either user can sever the communication tie at any time.

Another example of a conventional social network model is the Unidirectional Follow model, an example of which is Twitter. Under this model, a user (A) explicitly “follows” another user (B) without the other user B having any say in the matter. User B can optionally choose to follow user A. Any user can at any time “un-follow” someone they're following.

Yet another example of a conventional social network model is the Unidirectional Invite model used by Path, for example. Under the Unidirectional Invite model a user (A) explicitly invites another user (B) and only if user B accepts the invitation will the two users' information appear in each other's main feed (similar to the Bi-directional Invite model above). However, if user B does not accept the invitation user B can still observe user A's activity and information. Any user can at any time sever a connection with someone.

The social network model used by the SocialParent platform described herein is the Trusted Unidirectional Add model. Under the Trusted Unidirectional Add model a user/family (A) explicitly adds another user B to their private circle. User B is optionally notified of being added to a private circle but does not have to accept or reject the addition in order for user A's activity and updates to be shared with user B. User B receive user A's activity in their main feed going forward. User B can optionally choose to add user A to user B's private circle. User A can also remove user B from his/her private circle at any time without user B being notified. If the relationship is unidirectional (e.g., user B is in user A's private circle) then user B can “mute” user A in order to stop receiving their activity feed.

Another unique feature of the SocialParent add model, as opposed to a conventional invite model, is that it transparently permits non-members to participate in groups and plans. Group members or plan invitees can be either existing member families or non-member email addresses. In this way 1) users gain immediate benefit without requiring that all their participants first sign up for the service and 2) non-members can see first-hand the benefit of the service and can be repeatedly gently coaxed into joining the service through the emails that they already receive as an essential part of the service, sent from people they know an trust.

Under the family-oriented model or family-to-family model of an embodiment a user first creating a family account is immediately presented with the concept of “family nickname”. This emphasizes the family-oriented nature of the account, while at the same time creating a “handle” or moniker that is used to refer to the new family throughout the service. Subsequent to entering the nickname, the user adds their personal information, which includes but is not limited to their first and last names, email address (which becomes their user ID), password and home zip code to name a few. When the user has entered their personal information, the new family is created in the database along with a login for the parent that is creating the account. The zip code is subsequently used to recommend nearby families and activities.

The new user is then prompted to add family members as part of their family, or other families to their “trusted circle”. New family members of an embodiment include one or more of other parents, children, pets, and guardians. As parents or guardians are added, login are automatically created for them by the system, and a random password is generated and sent, along with a link to download the application, to the email entered for the parents or guardians.

All parents have the same privileges within the SocialParent network or platform. While parents have full access to all of the family management features, guardians have limited access under an embodiment in that they can log in and send posts, but cannot manage the family in any way. The family-orientation is strengthened by the fact that all postings are family-to-family, so everything sent to the family is equally visible to all parents. Despite the pervasive family-oriented model, however, posts do include information indicating which individual made the post [E.g. “Homer (Simpson Family)”]. Thus, all messages include metadata that identifies both the originator family and the originator individual (as identified by their email-address/login-id).

As described herein, the system of an embodiment enables non-member inclusion in that families can be included that users want to include in a group or a trusted circle when those families do not have, nor do they want, a SocialParent account. In supporting this capability, all distribution/member lists in the system allow for either a SocialParent family ID or a regular email address. When a user wants to add a family, they can search for existing SocialParent families by a parent's name or email address. If they do not find a matching family, they can still add a friend by entering the friend's name and email address. A friend added in this way appears in the distribution/member list along with SocialParent families, only in a separate section to make clear to the user that they are not already a SocialParent family.

When messages are sent to the member of a distribution/member list, families added by email get email copies of group activity. While these families cannot reply to these messages, they are permitted by the system to see all activity posted to the group they are in and, in the case of plans, they can accept or decline invitations.

When a new user is added to the service, whether by creating a new family, or being added as a parent to an existing family, the platform modifies all existing distribution/member list references to the email in question to reference the new family rather than the raw email address. The platform includes indexes for this purpose. Whenever a raw email is added to a distribution/member list, an entry is made in the index associated with the list. The platform of an embodiment uses three indexes, but is not so limited. The three indexes of this example embodiment include an index corresponding to members of a trusted family circle, an index corresponding to members of other groups, and an index corresponding to invitees to a plan. When the user gets created, the platform inspects the indexes to retrieve and modify all lists that include the new user's email and replaces the entries in those lists with the new family's family ID. Upon completion of modification of the list references, families that previously showed email addresses for those families will now see the family listed in the family section instead.

Another form of reconciliation of an embodiment occurs when a new family is created. The new family is updated to include all of the groups and plans in which it had previously been an email-only member. The indexes mentioned are used to add the groups and plans in which the new user is a member.

Closely related to the previous case is one where a second parent is added to an existing family. Any distribution/member list references to the new parent's raw email need to be fixed up to family's ID, and groups and plans to which the parent had been previously added need to be merged with the existing groups and plans in the family.

The SocialParent system of an embodiment supports the integration of plans and threads. All plans of an embodiment include a conversation thread associated with them. In addition, to support the natural evolution of conversations into plans, the platform supports the creation of plans from threads.

Every message in the system has a unique message ID property and is part of a single conversation thread. Each message has a ThreadID property that identifies in which thread that message belongs. When a new message is originated (i.e. not a reply to, or comment on, an existing message) the thread ID of that message is set to the message ID of the message itself. Subsequently, as comments or replies are made, those comments/replies (which are messages themselves as well) are tagged with the same thread ID as the original message, which in turn is the message ID of the original message.

In addition to the other information associated with a plan (invitees, times, venue, etc.), each plan has a ThreadID property that associates the plan with a conversation thread. Under one scenario of an embodiment, a plan is created, and the ThreadID is set by the first comment of the thread associated with the plan. This scenario in which the plan is created first provides a convenient central location for discussion about the plan once it is created. An example includes a scenario involving a potluck dinner where the time and venue are known from the start, but there is ongoing conversation about the items that are to be brought to the dinner. Given the plan/thread associative model in place, this is implemented by providing a button on the plan page to add a comment. The first comment determines the thread ID, which is then assigned to the plan. From then on, the plan is permanently associated with that thread and all comments in the thread.

An alternative scenario is also provided in which a thread exists and participants want to turn the thread into a plan. The plan/thread associative model of an embodiment therefore alternatively allows for attachment of an existing thread to a plan at the time that the plan is created. In this case, SocialParent includes an icon or button in the conversation thread view that enables the user to create a plan from the conversation. In response to selection of the icon, the system creates a new plan for the user, initializes the invitee list with the “active participants” of the existing conversation thread, and associates the thread with the new plan by setting the plan's ThreadID property. The term “active participants” as used herein means only those recipients of the conversation that actually participated in the thread. This reduces what may be an extensive list (say the members of a large group) to those parties that are probably interested.

The processing of self-expiring groups under an embodiment includes the assignment of an expiration date (optionally “never”) to every group, and this expiration date is stored with the group information. When a group expires, the platform “hides” it from the groups list in the application.

Prior to expiration, users are prompted to add families from the expiring group to their own circle of trust for ongoing interaction. The platform prompts the users to add expiring families by injecting SocialParent-initiated messages into the family's feed. In so doing, a background task runs on the platform and pulls out upcoming group expirations, and generates and sends the reminder message to members of the group that are SocialParent members. Members of the group that are not already SocialParent members will receive an email informing them of the group expiration and encouraging them to join the SocialParent network.

Following expiration of a group, the expired group can be accessed in two ways. Under one process, a hidden group that is expired can be un-hidden by the platform. Also, expired groups can be searched along with existing groups for SocialParent family name/nicknames.

The features of SocialParent described herein (family as core social unit, permanent/temp/affiliated group mgmt., and many-to-many social interaction) deliver numerous services to a user. The services include, but are not limited to, family introductions, auto-curated family resources, trusted network recommendations and advice, and family circle management.

The platform of an embodiment creates serendipity through compelling and relevant family introductions. A family can be introduced to other “similar” or “interesting” families based on parameter matching at the SocialParent platform. Examples of such parameters include interests, ages, and location. For example, a family may be presented with: “You may want to connect with the Smith family as they also have two boys close to age to your kids who also share similar interests in science, reading and bowling.”

The platform of an embodiment also provides auto-curated family resources.

Based on a family's collective interests and activities, targeted services and products are suggested to the user, including books, music, events, toys, clothing, and household items. For example, a family may be presented with: “There is a science fair next weekend 5 miles away from you that your 9 year old may be interested in attending.” As another example, a family may be presented with: “Here're the top 10 books for children who love soccer.”

The platform of an embodiment enables trusted network recommendations and advice. A family's network of trusted families can also recommend and suggest various things to them including restaurants, books, music, events, toys, clothing, and household items. These trusted recommendations are immensely more useful to a family that an anonymous recommendation they might find on the Internet or similar large user groups as they're personal and extremely targeted. For example, a family may be presented with: “We just read the book, “The Adventures of Hugo Cabret” to our 9 year old Alex and he loved it. Highly recommend it to you all!” As another example, a family may be presented with: “We're planning on going to the art festival in San Francisco this weekend. We had a great time last year and thought you might want to know about it.”

As the family, and especially the kids move in and out of different circles, the parents need to be able to stay on top of the changes in real-time. For example, an auto-expire group representing families of a seven-year old's second grade class is formed by a teacher or class parent in September and all families in that class are added to that group. A month before the class ends (in April) an automated message is sent to all the group members reminding them to add any families from that auto-expire group to their permanent trusted circle of families. The actual auto-expire group would be archived for future reference by any of the member families.

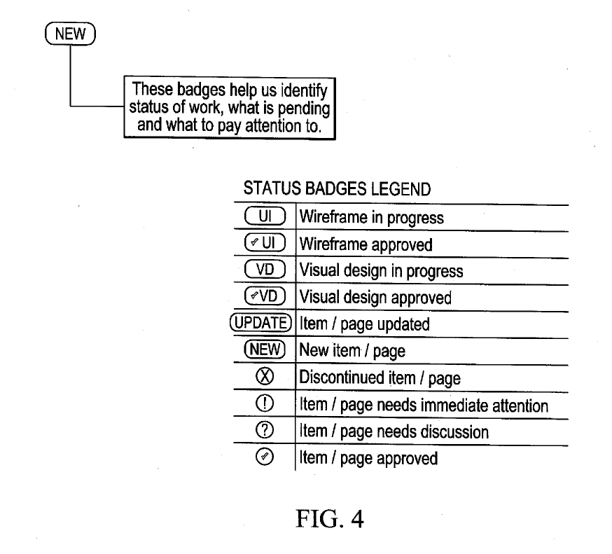

FIG. 4 is a status badge legend, under an embodiment.

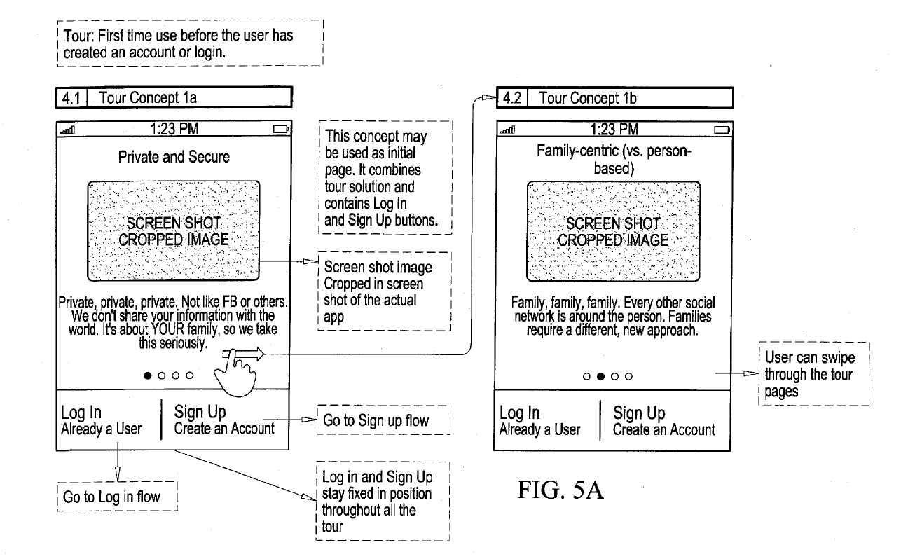

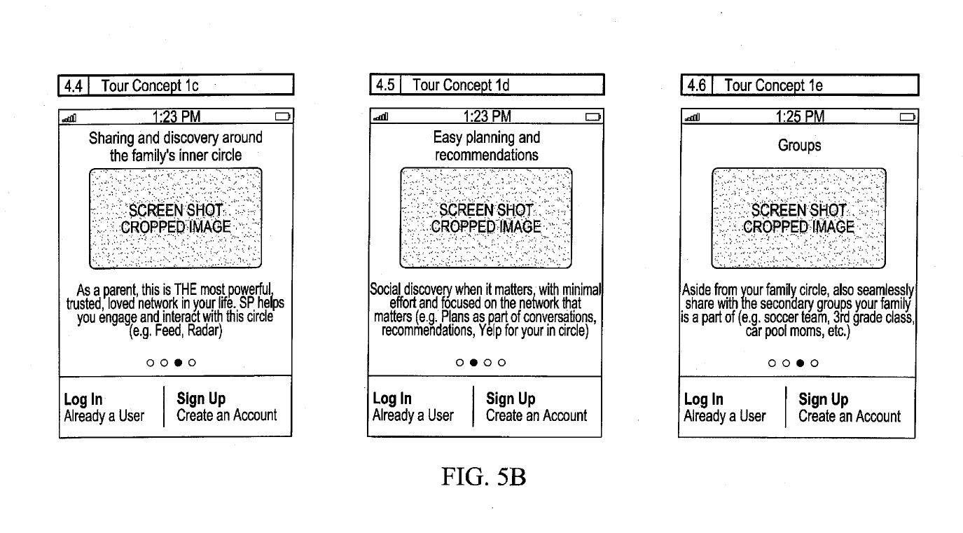

FIG. 5 is a tour presented by the social family networking application to the user prior to user creation of account, under an embodiment.

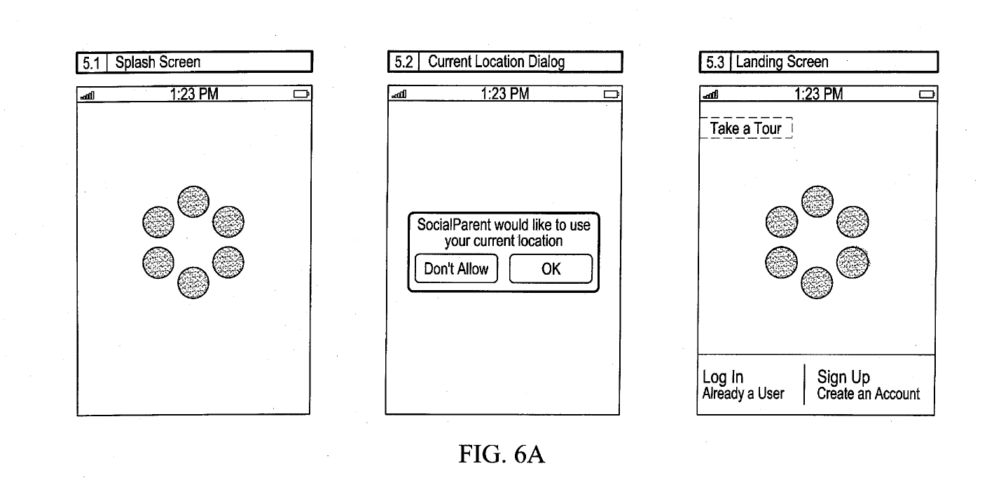

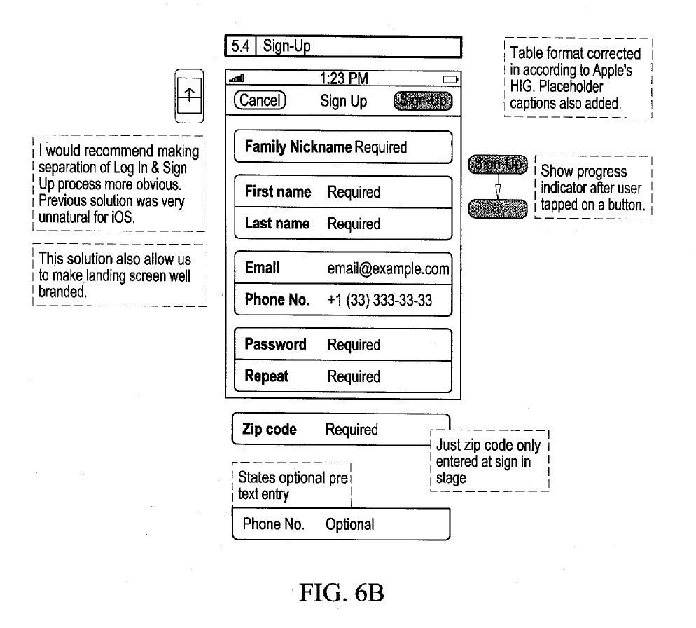

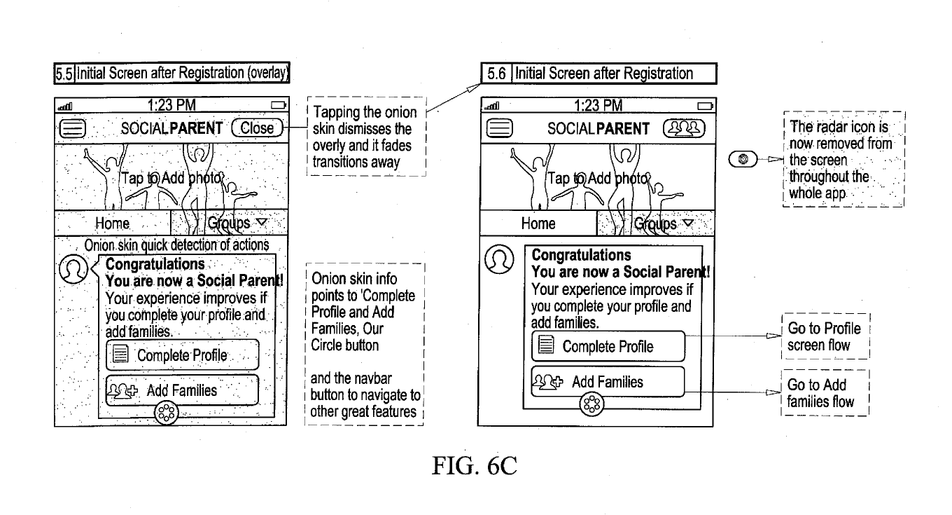

FIG. 6 is a set of screens presented to the user during user creation of an account with the SocialParent network, under an embodiment.

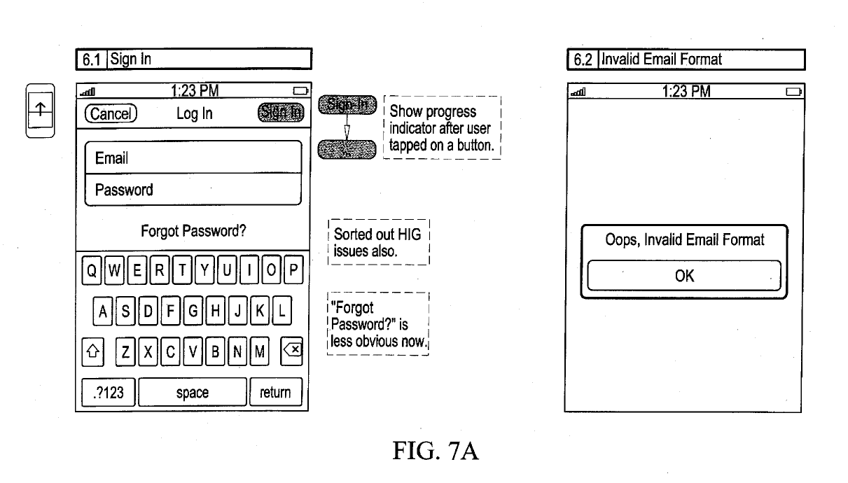

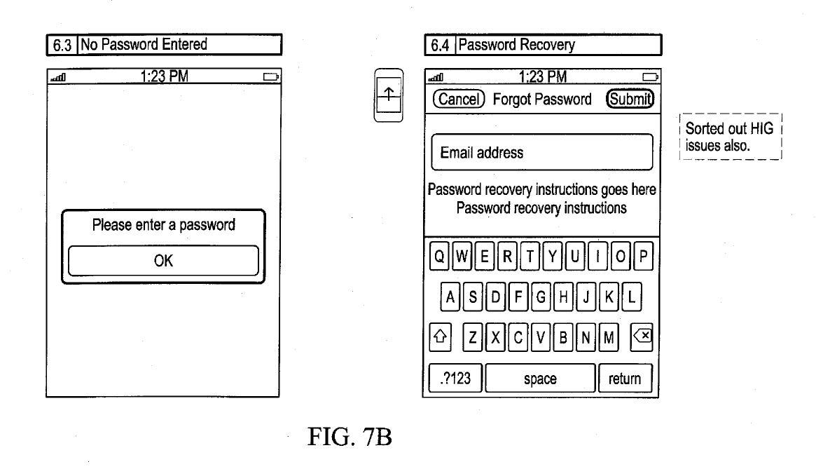

FIG. 7 is a set of screens showing a user logging into the SocialParent system, under an embodiment.

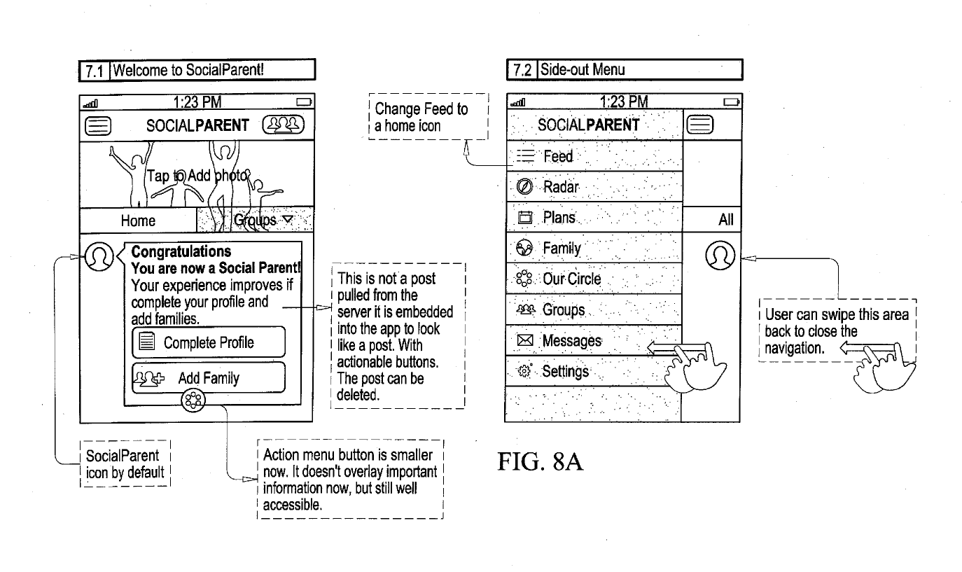

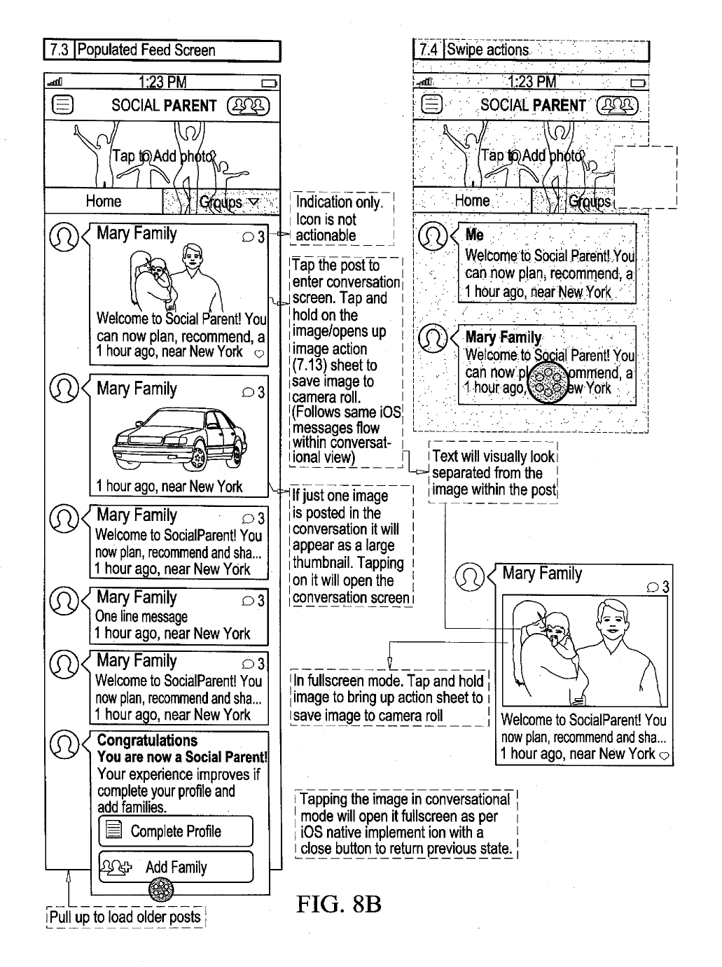

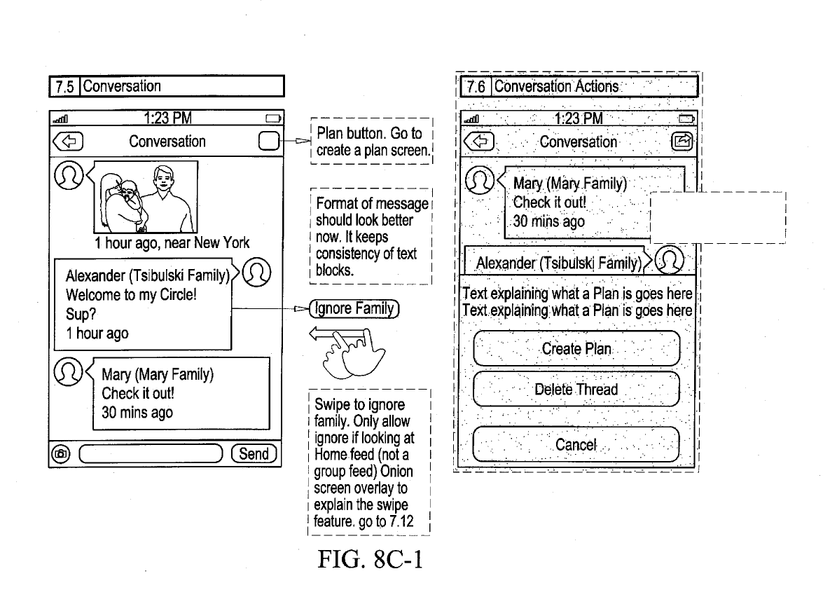

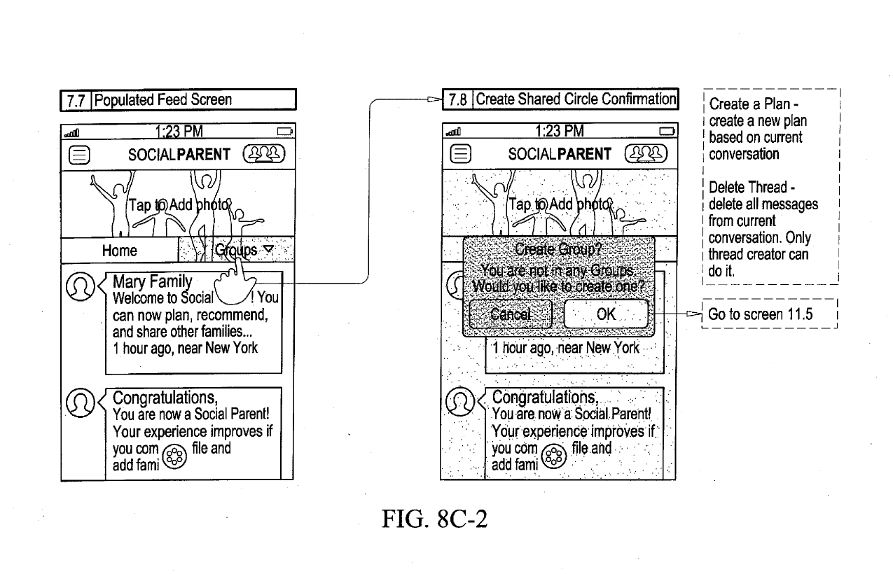

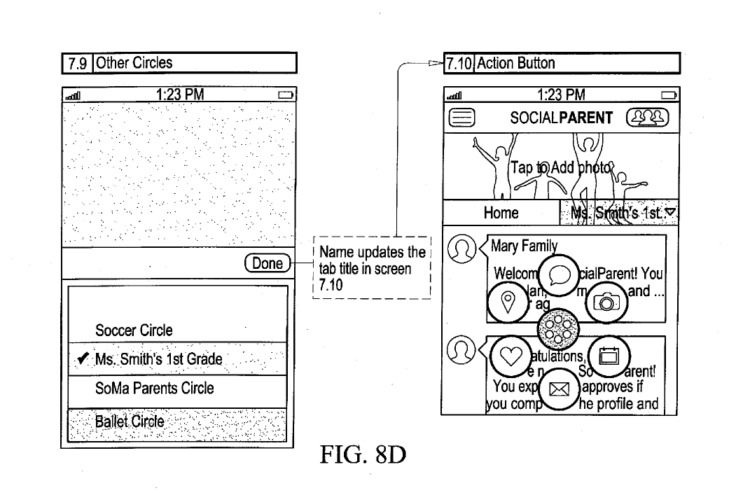

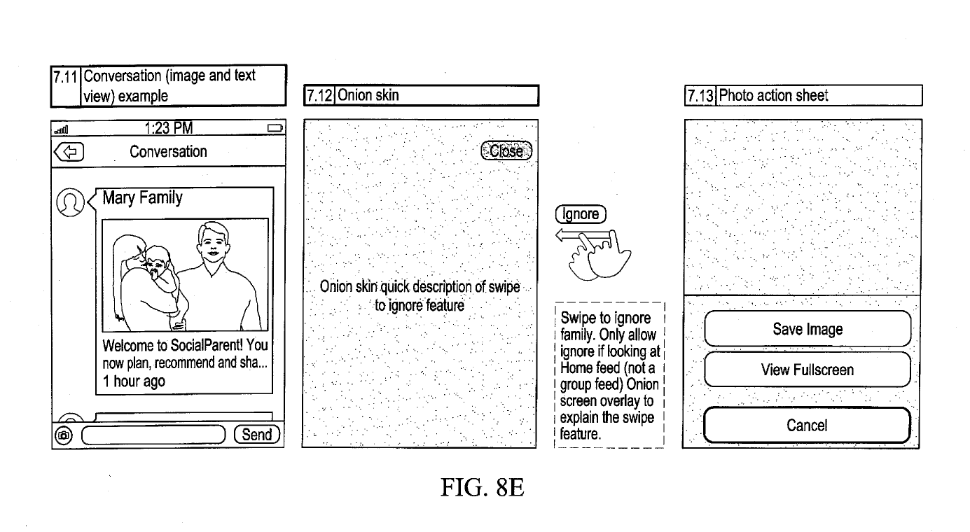

FIG. 8A is a set of screens showing a user feed, under an embodiment.

FIG. 8B is a set of screens showing a user feed, under an embodiment.

FIG. 8C is a set of screens showing a user feed, under an embodiment.

FIG. 8D is a set of screens showing a user feed, under an embodiment.

FIG. 8E is a set of screens showing a user feed, under an embodiment.

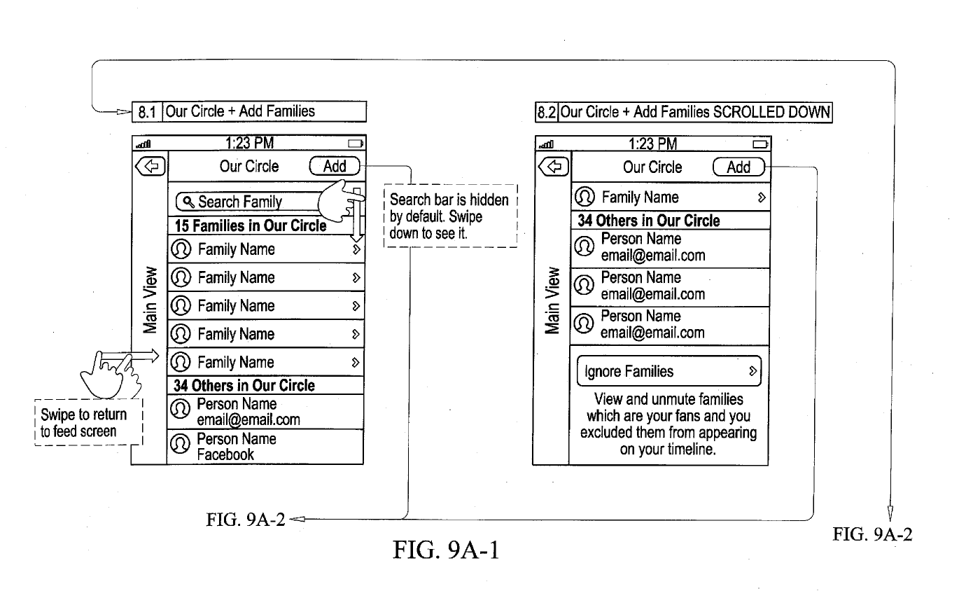

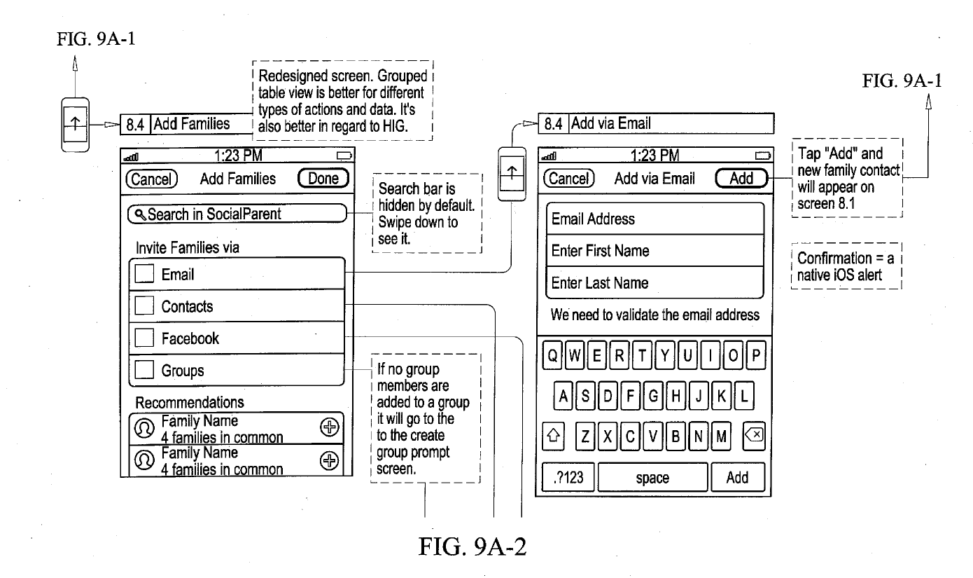

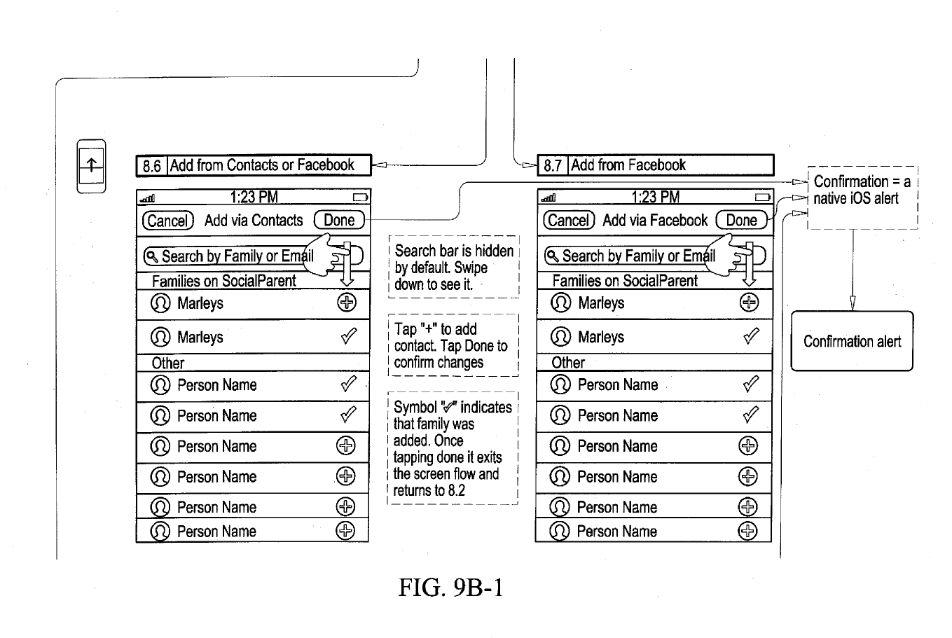

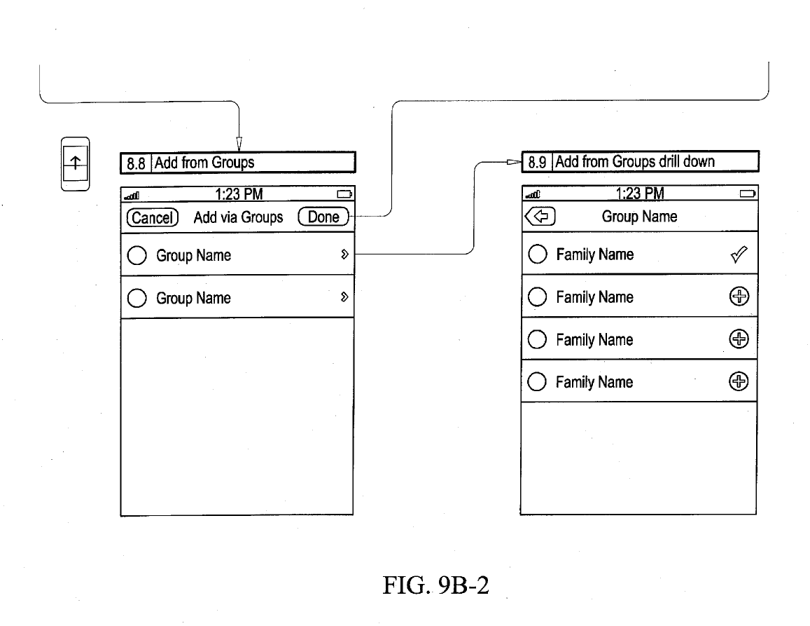

FIG. 9A is a set of screens showing user addition of families, under an embodiment.

FIG. 9B is a set of screens showing user addition of families, under an embodiment.

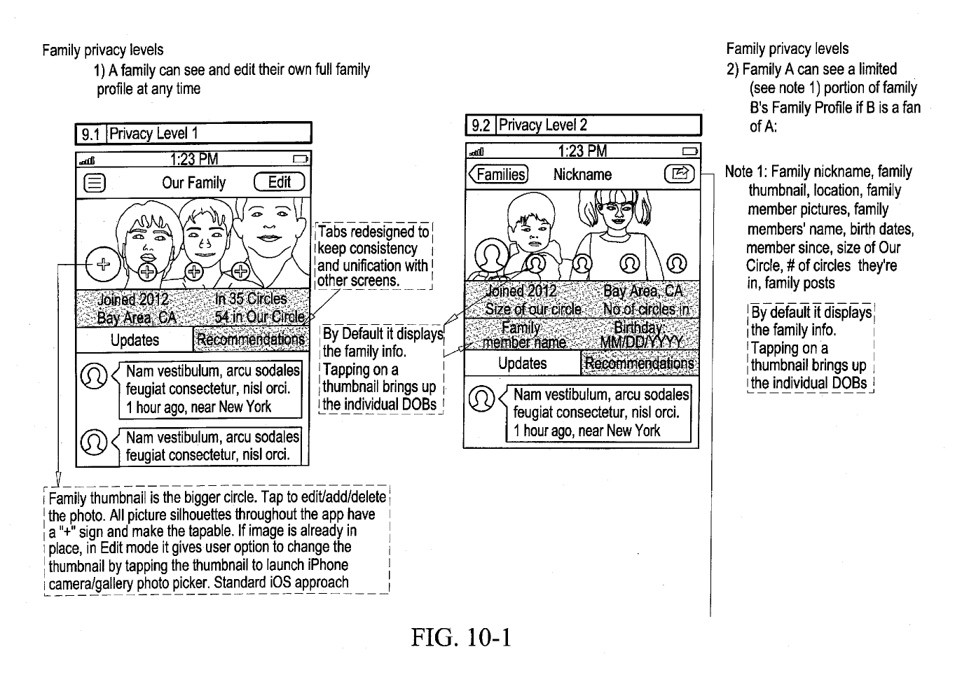

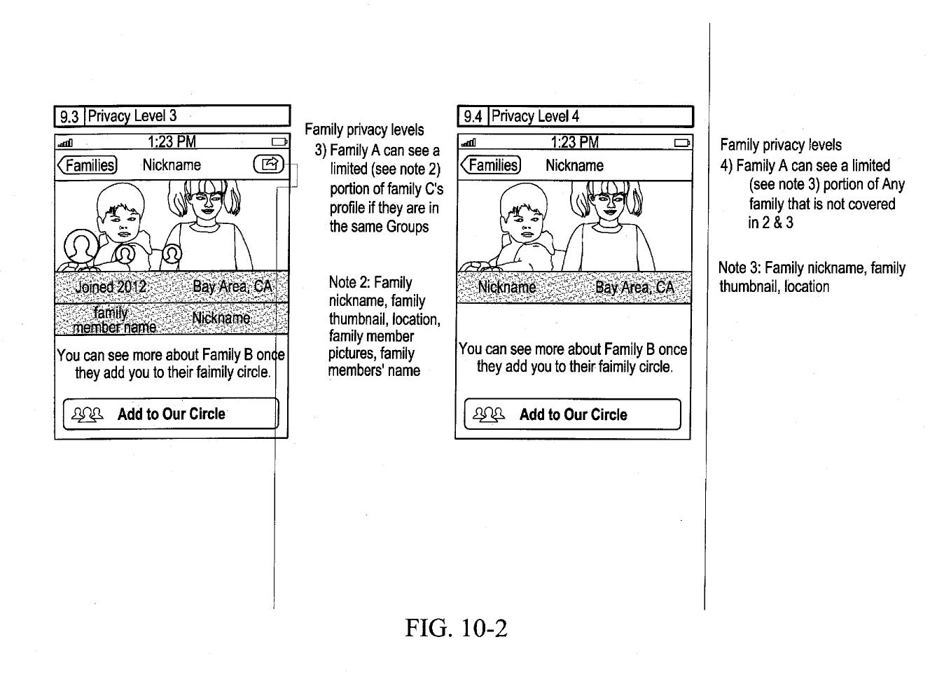

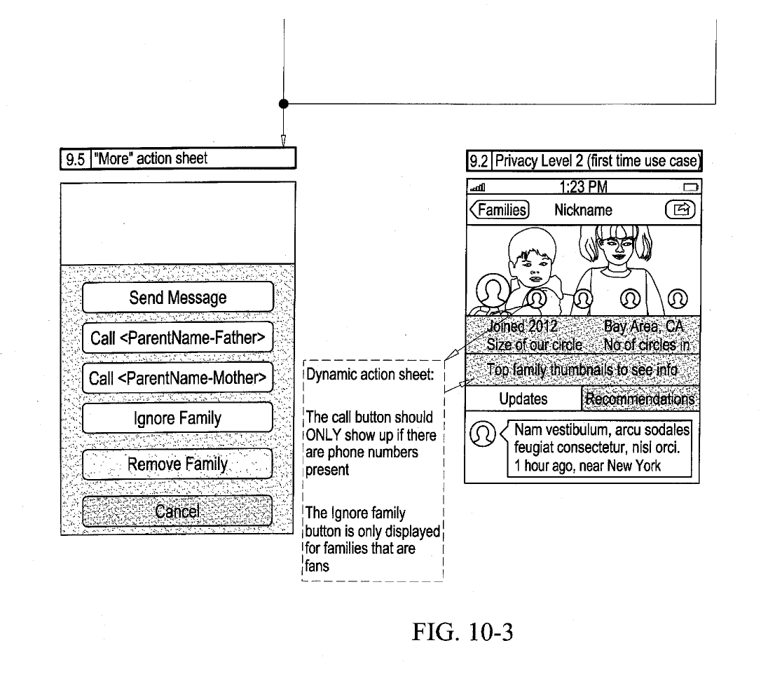

FIG. 10 is a set of screens showing user privacy level configuration, under an embodiment.

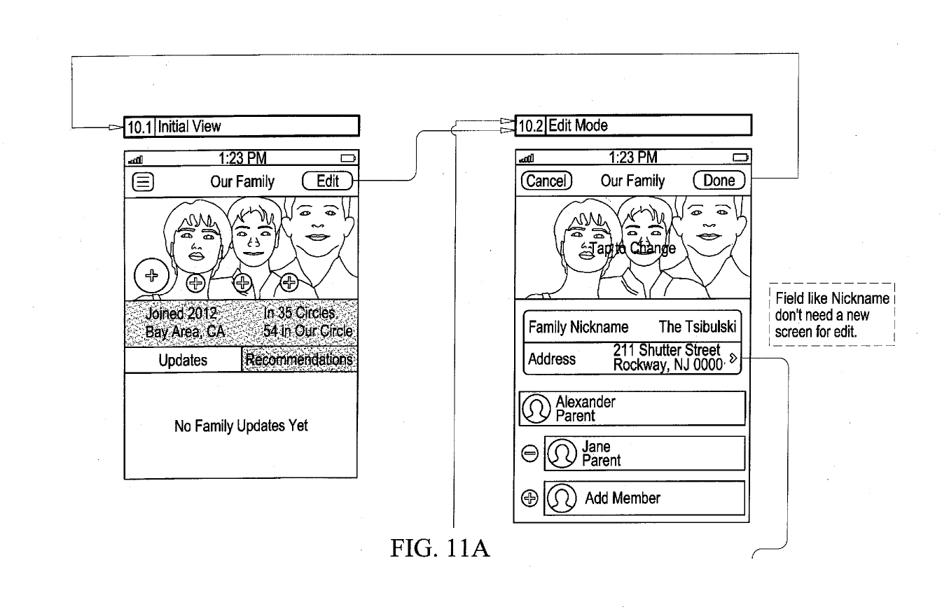

FIG. 11 is a set of screen shots showing a user adding a member to family, under an embodiment.

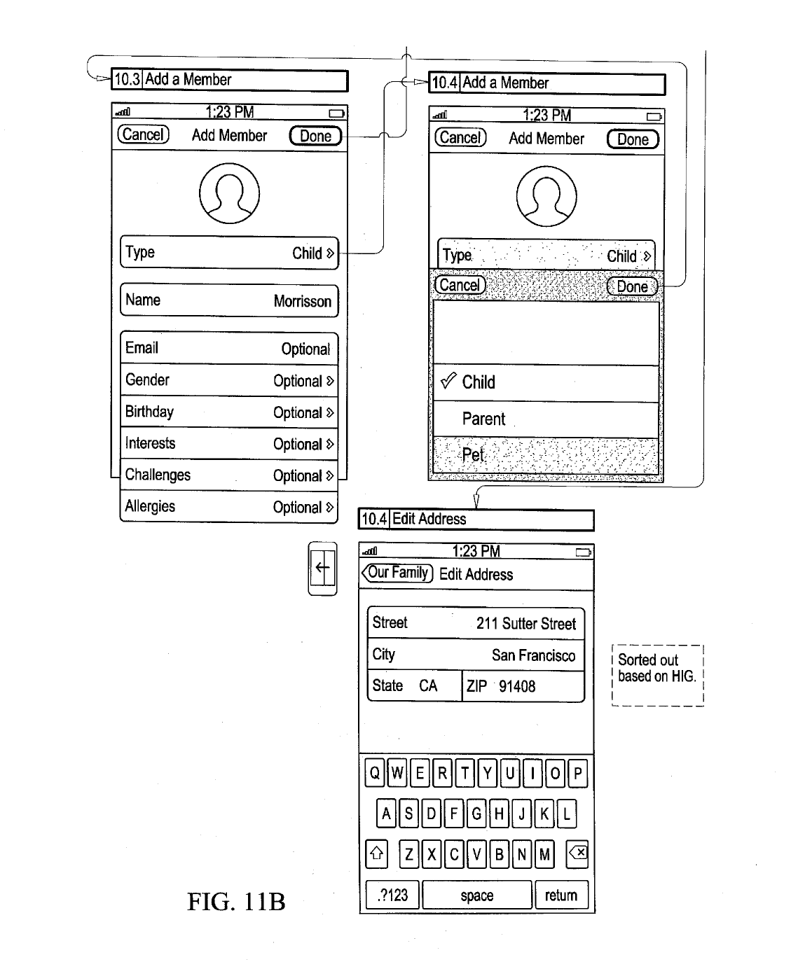

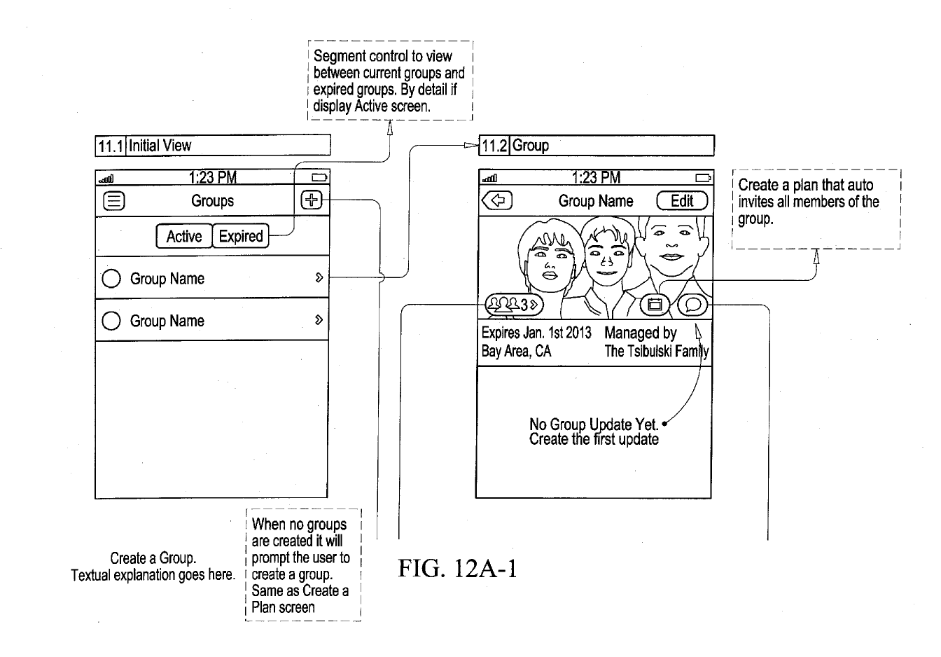

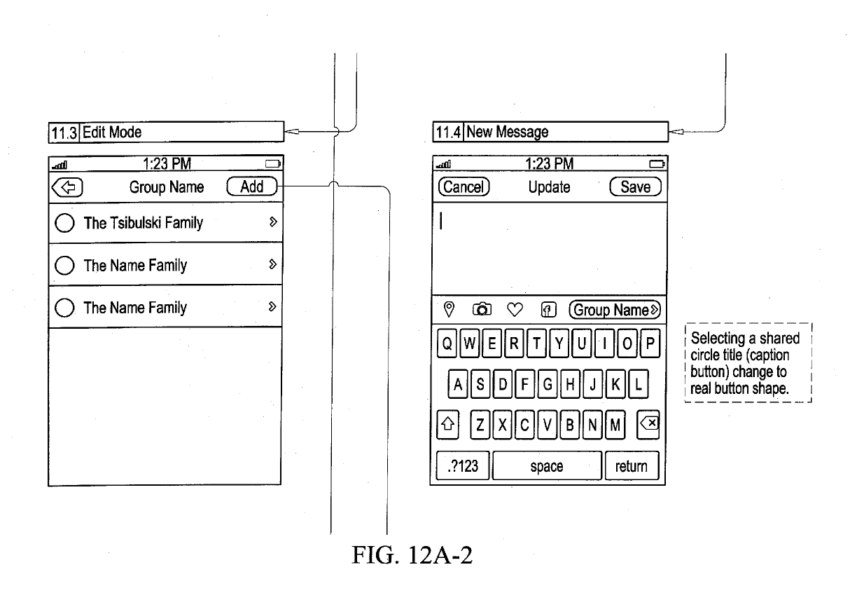

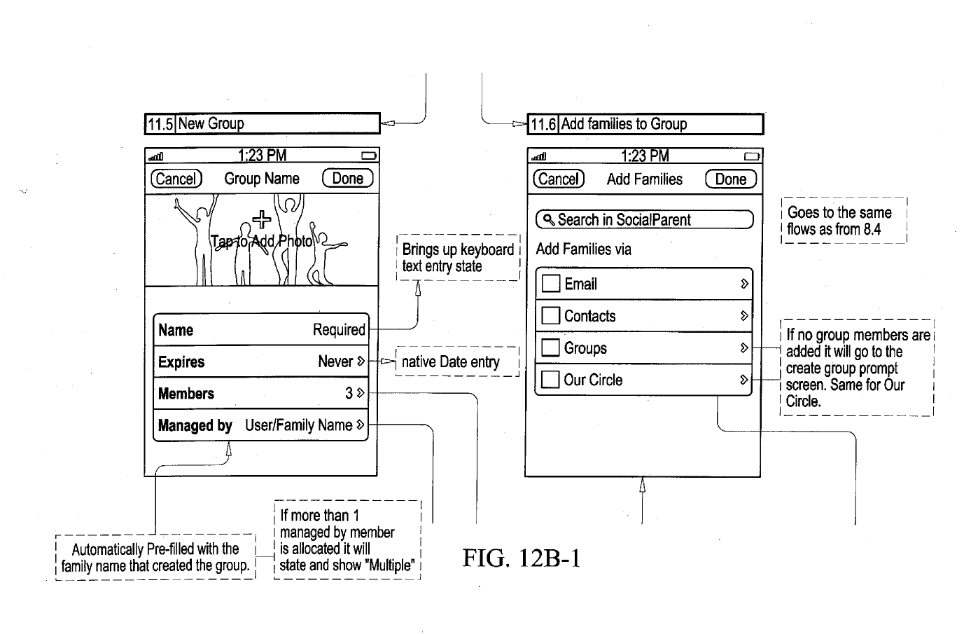

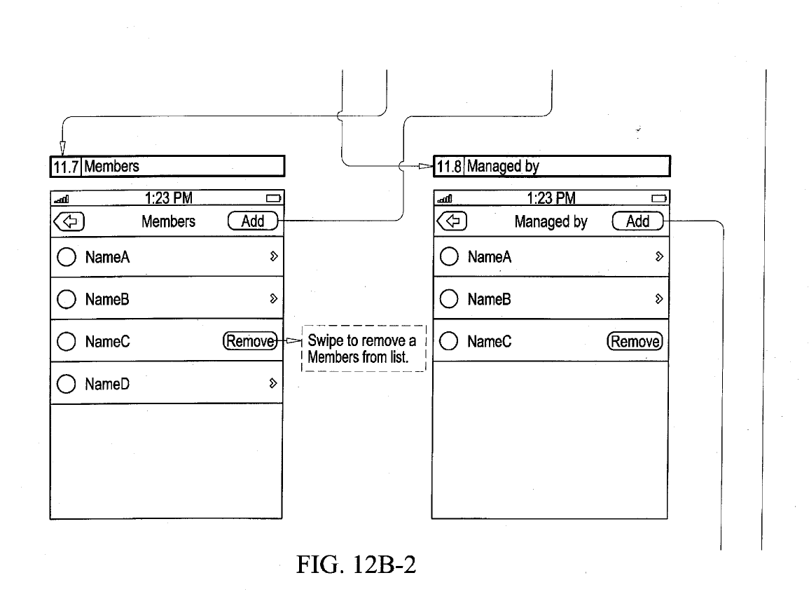

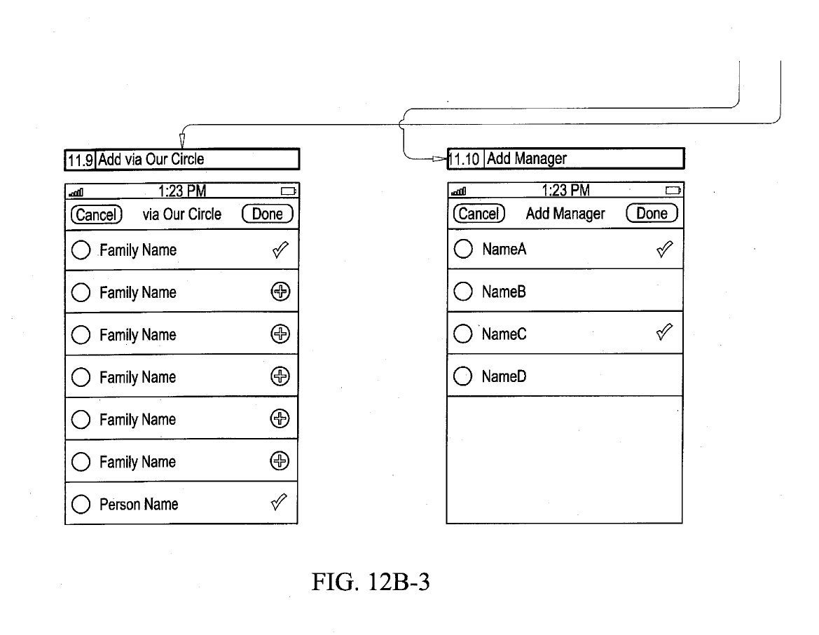

FIG. 12A is a set of screen shots showing a user managing groups, under an embodiment.

FIG. 12B is a set of screen shots showing a user managing groups, under an embodiment.

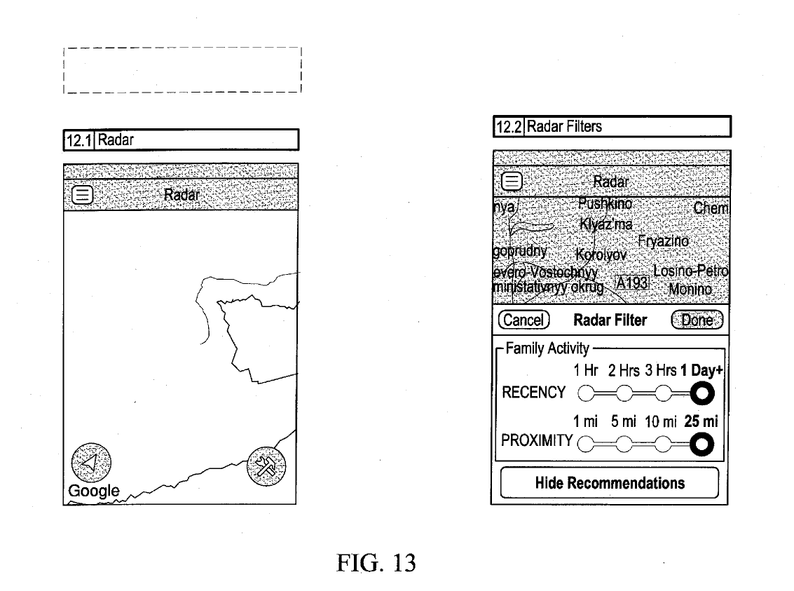

FIG. 13 is a set of screen shots showing radar functionality of the SocialParent system, under an embodiment.

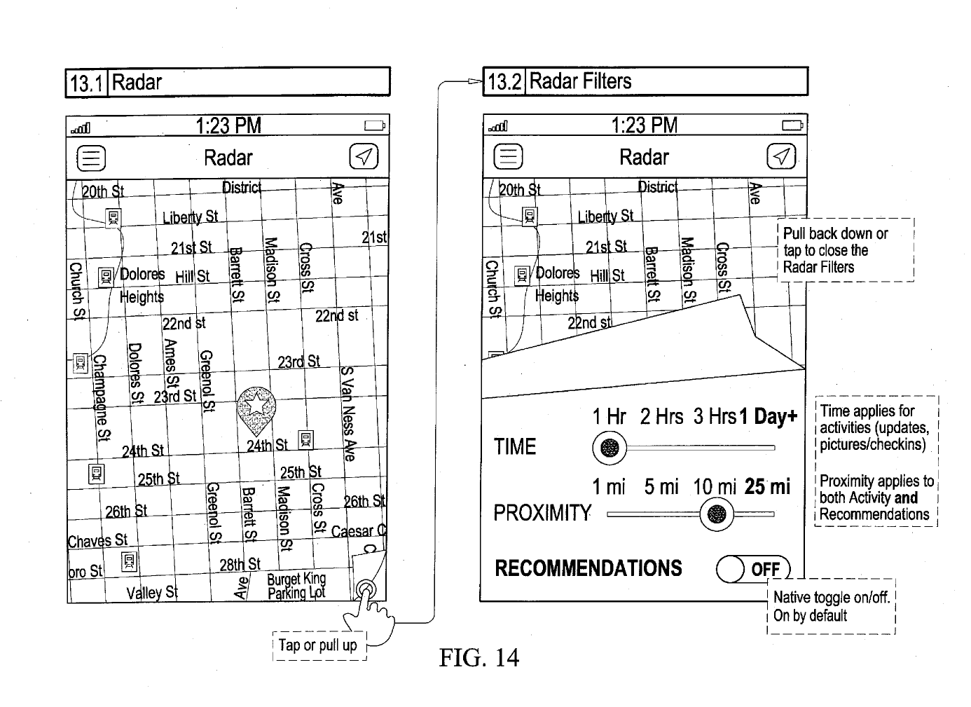

FIG. 14 is a set of screen shots showing radar functionality of the SocialParent system, under an embodiment.

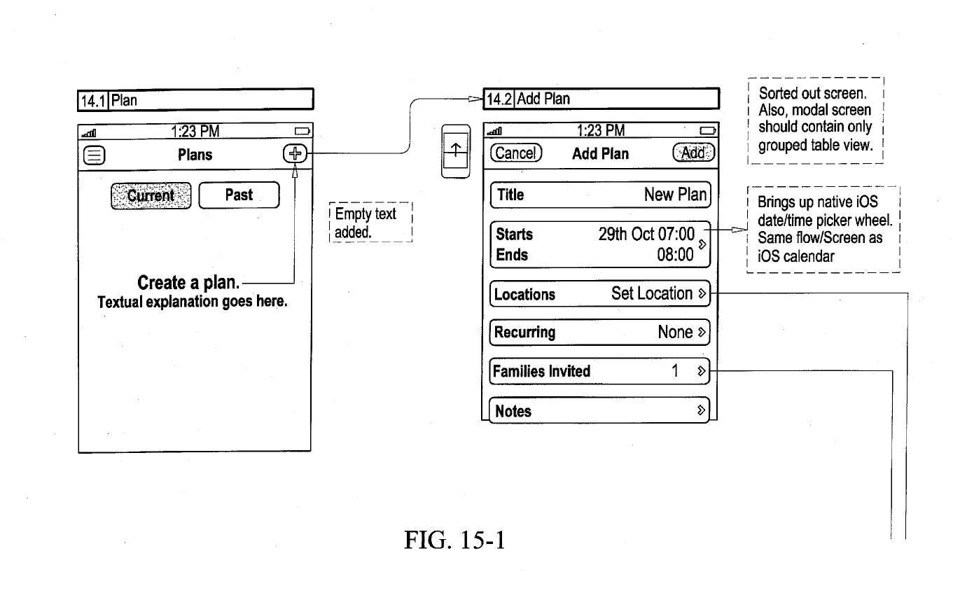

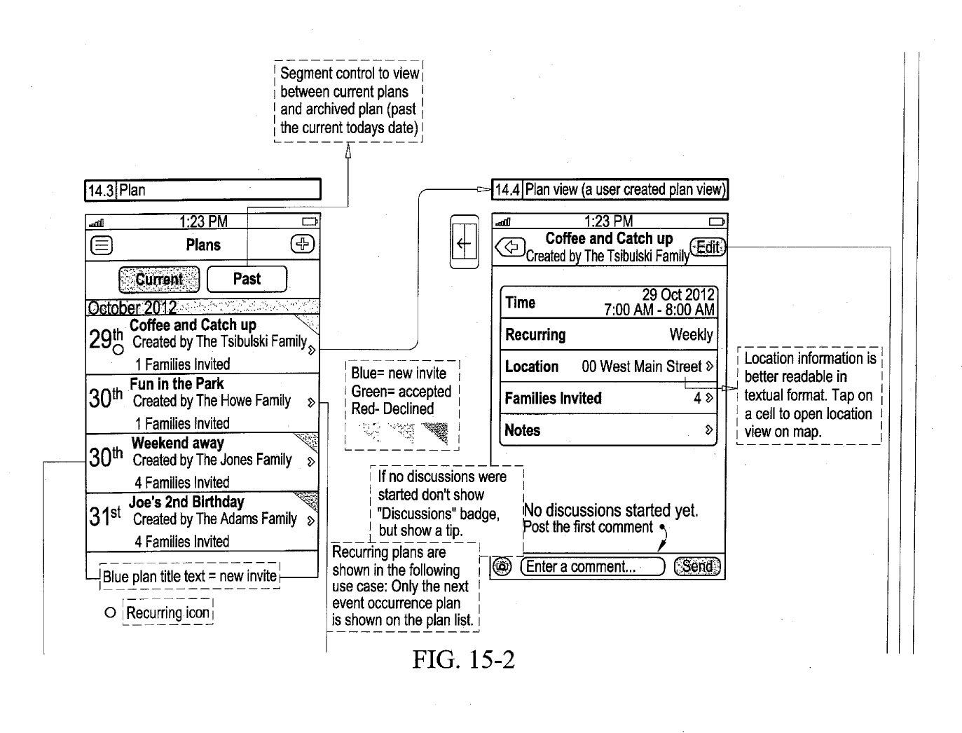

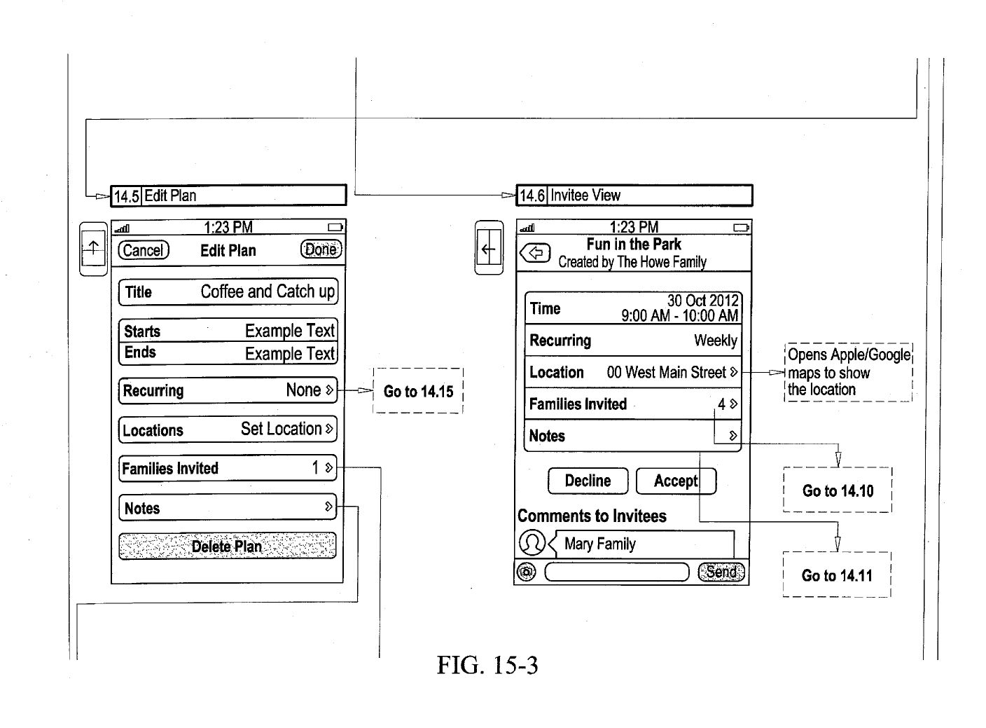

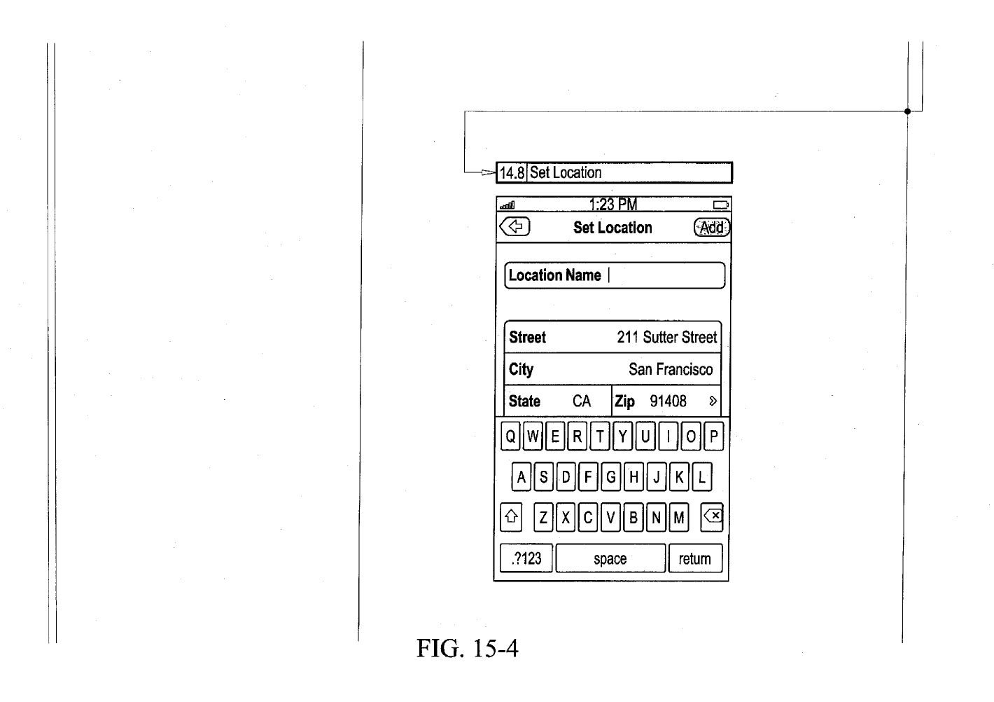

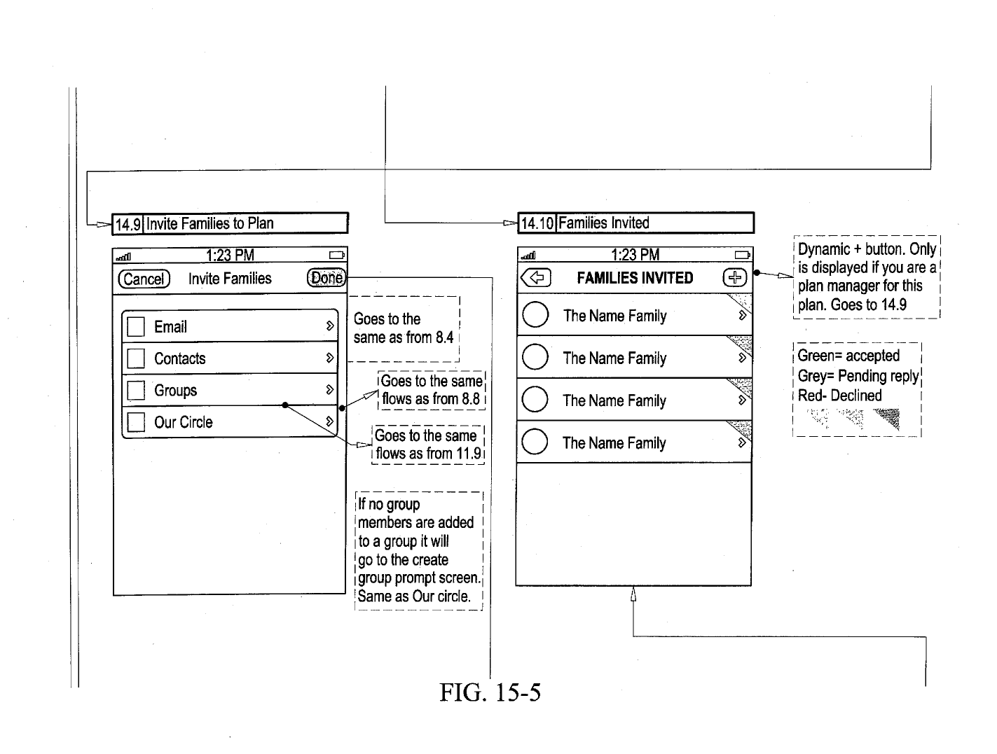

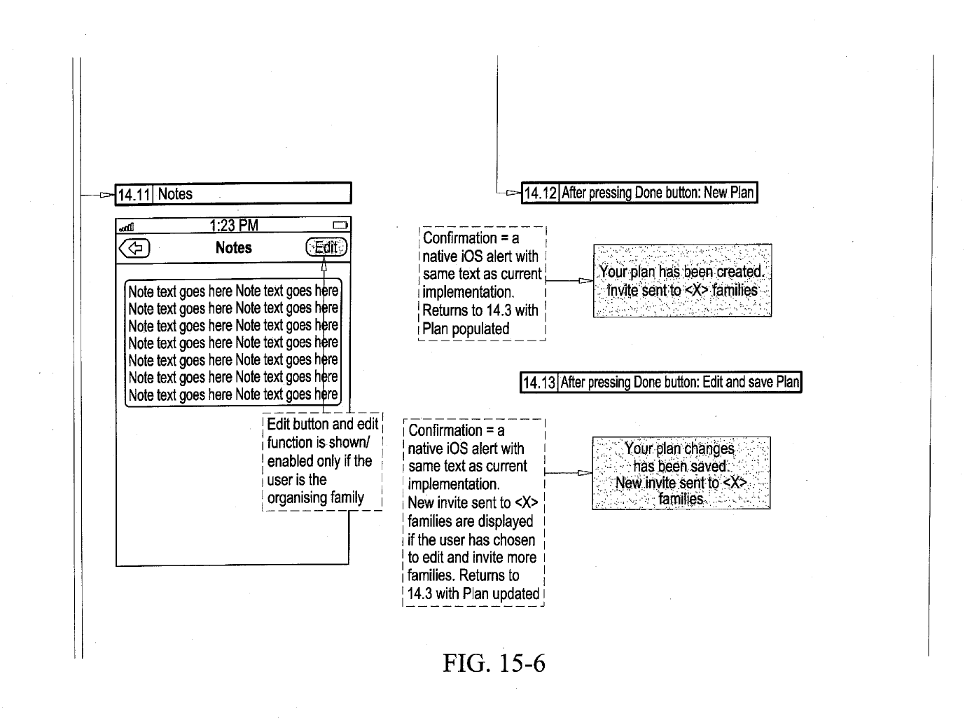

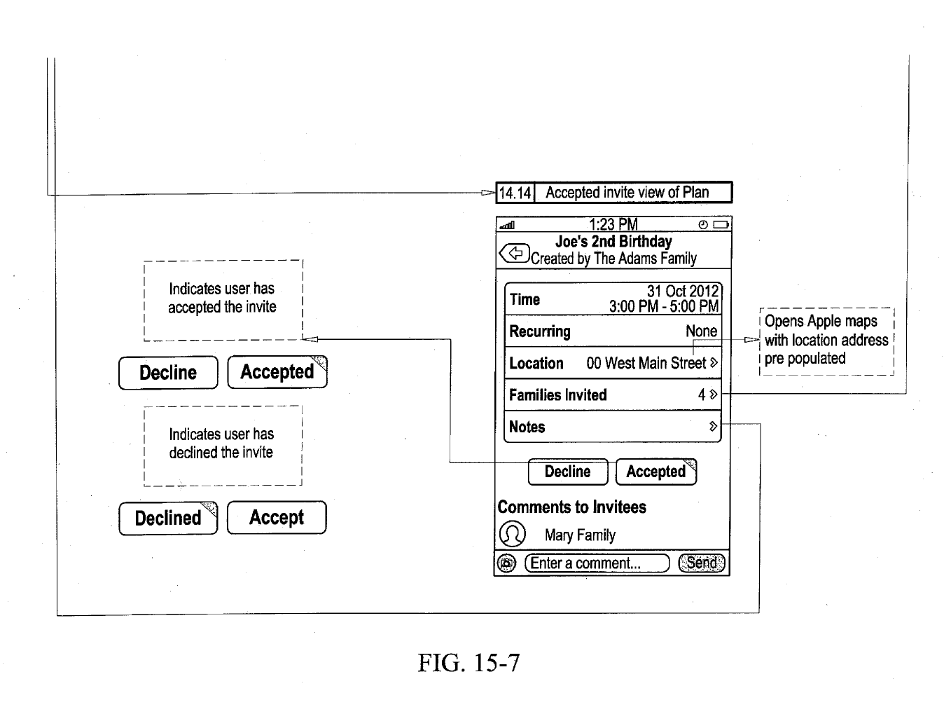

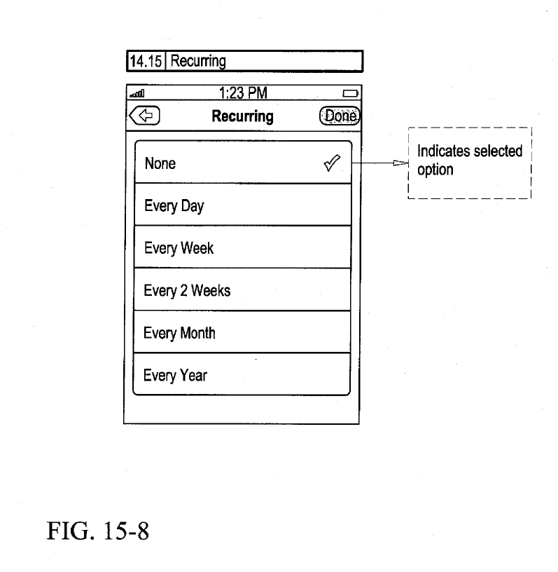

FIG. 15 is a set of screen shots showing user creating and editing of plans, under an embodiment.

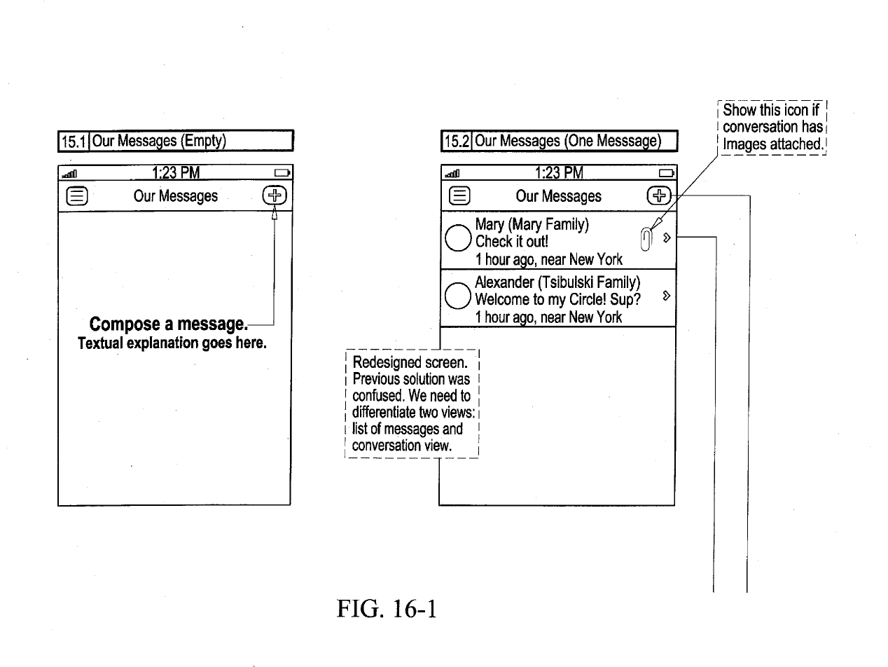

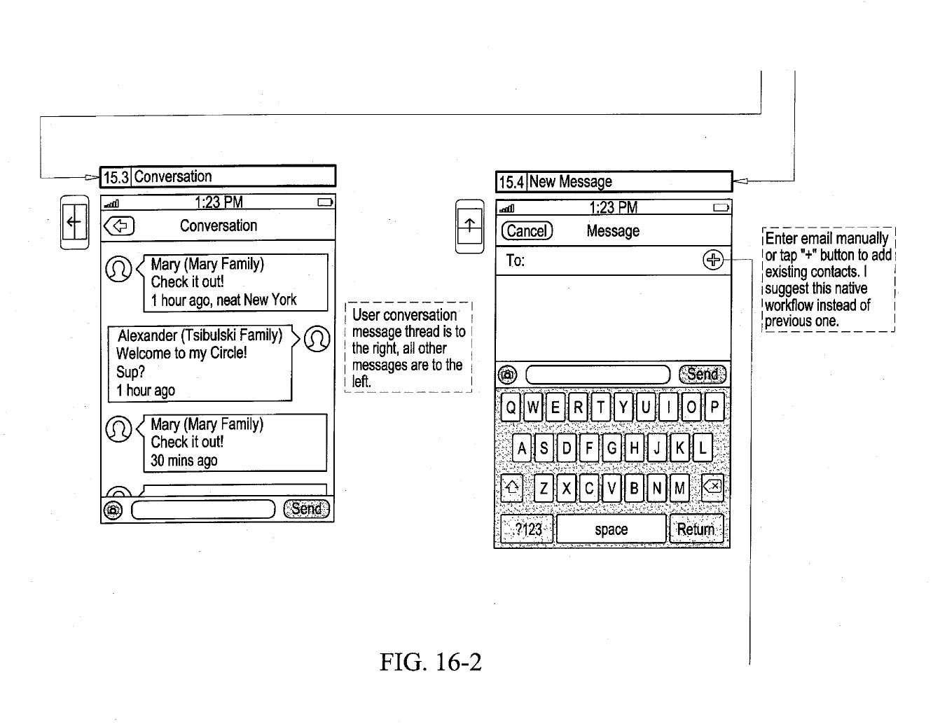

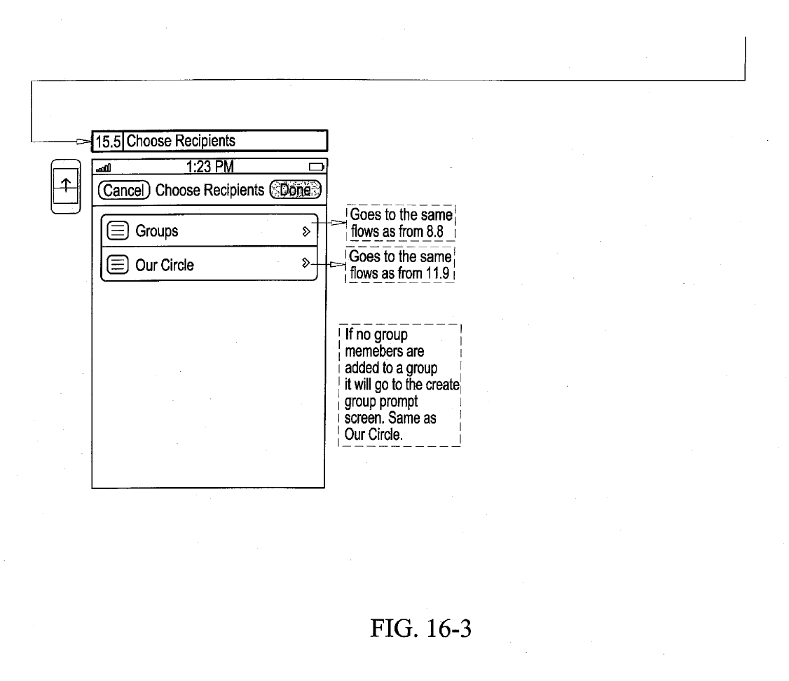

FIG. 16 is a set of screen shots showing use and functionality of application messaging, under an embodiment.

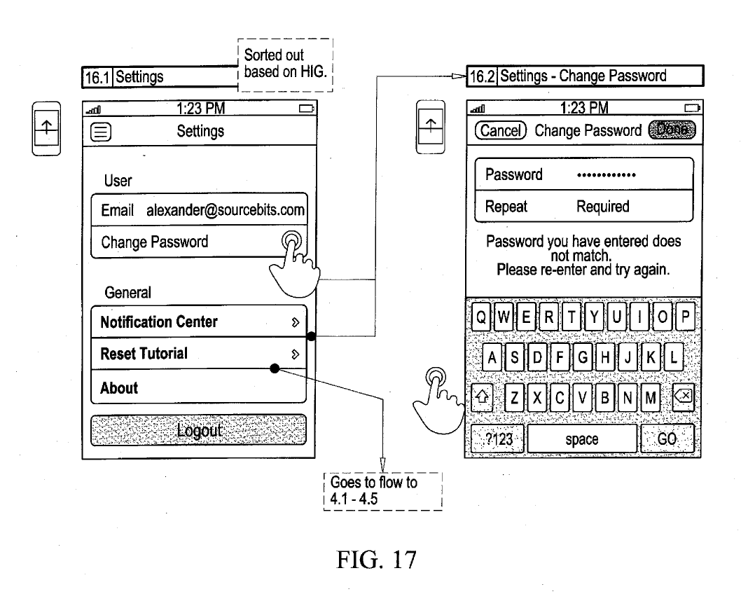

FIG. 17 is a set of screen shots showing a settings interface of the social family networking application, under an embodiment.

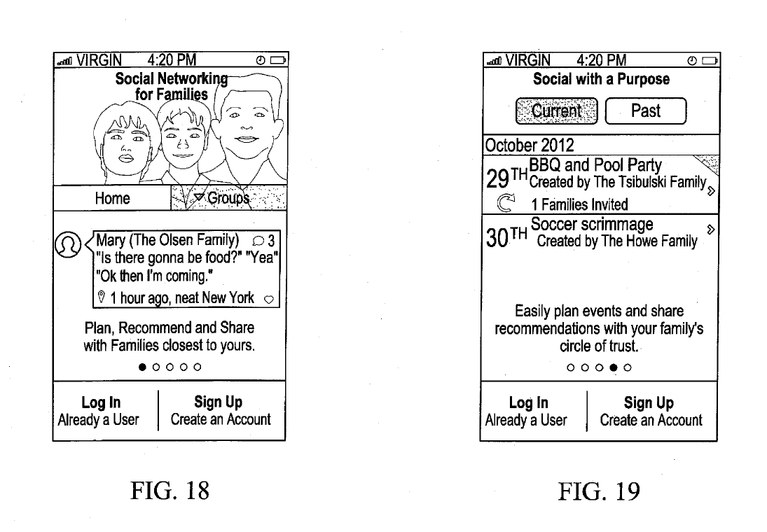

FIG. 18 is an application screen showing tour concept presented to user prior to user creation of an account, under an embodiment.

FIG. 19 is an application screen showing tour concept presented to user prior to user creation of an account, under an embodiment.

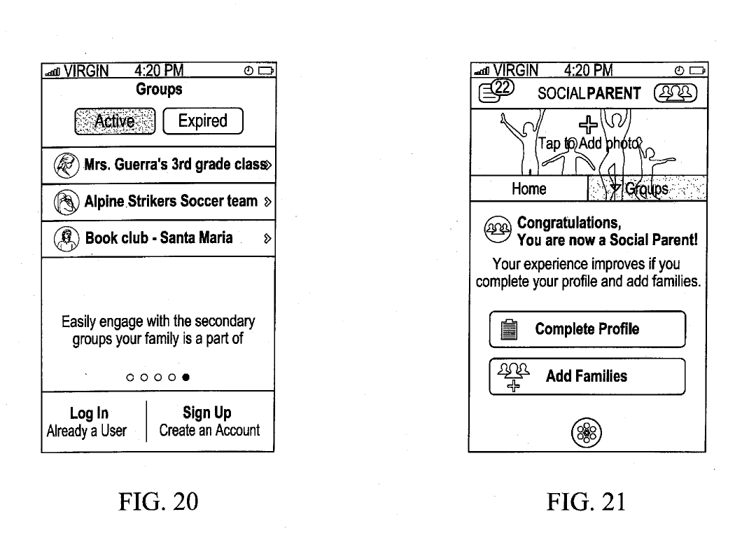

FIG. 20 is an application screen showing tour concept presented to user prior to user creation of an account, under an embodiment.

FIG. 21 is an initial application screen after registration, under an embodiment.

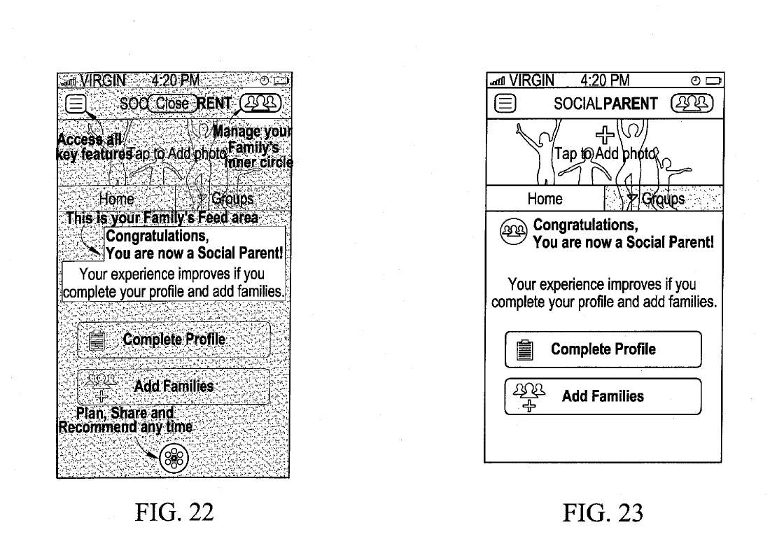

FIG. 22 is an initial application screen after registration, under an embodiment.

FIG. 23 is a welcome screen welcoming user to SocialParent, under an embodiment.

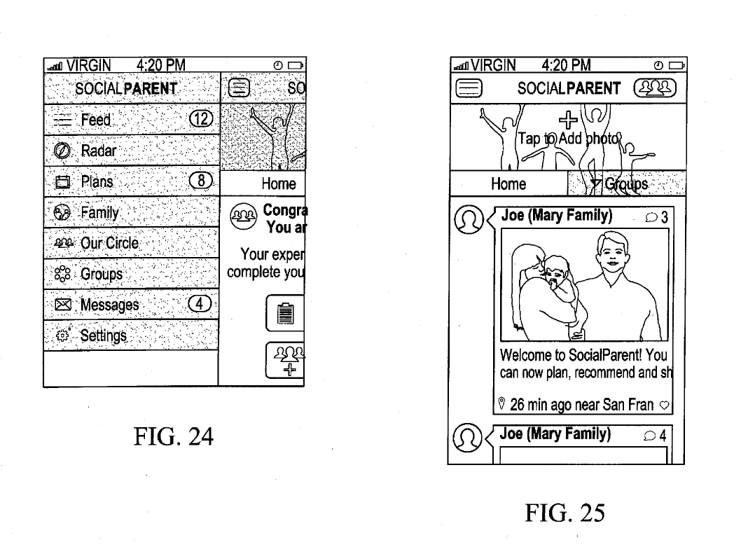

FIG. 24 is a slide out menu of a welcome screen, under an embodiment.

FIG. 25 is a populated feed screen, under an embodiment.

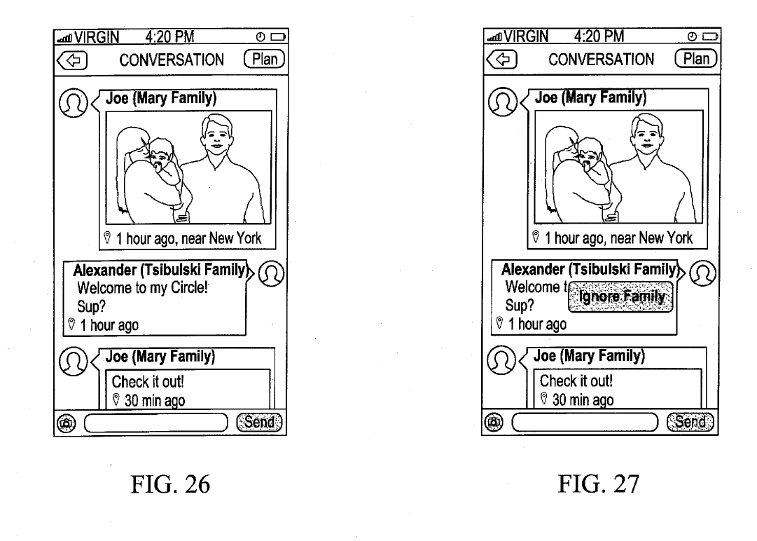

FIG. 26 is an application screen showing a conversation, under an embodiment.

FIG. 27 is application screen showing a conversation including ignore family function, under an embodiment.

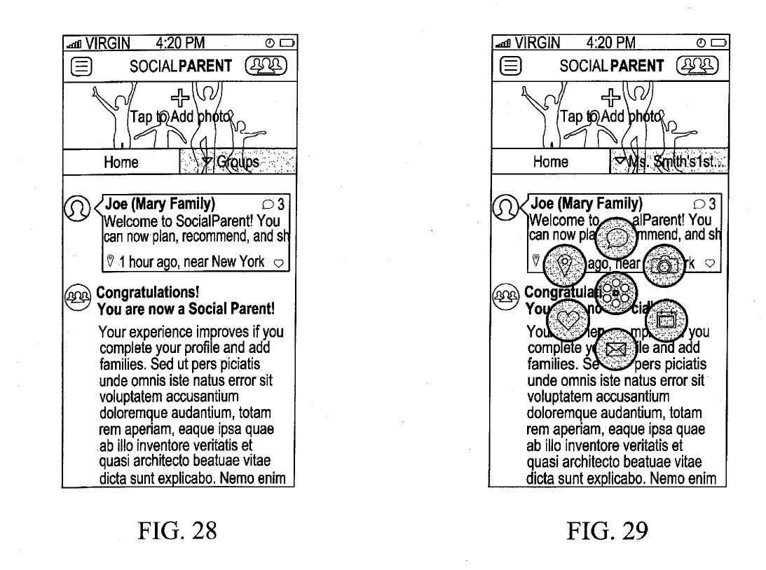

FIG. 28 is a populated feed screen, under an embodiment.

FIG. 29 shows action buttons, under an embodiment.

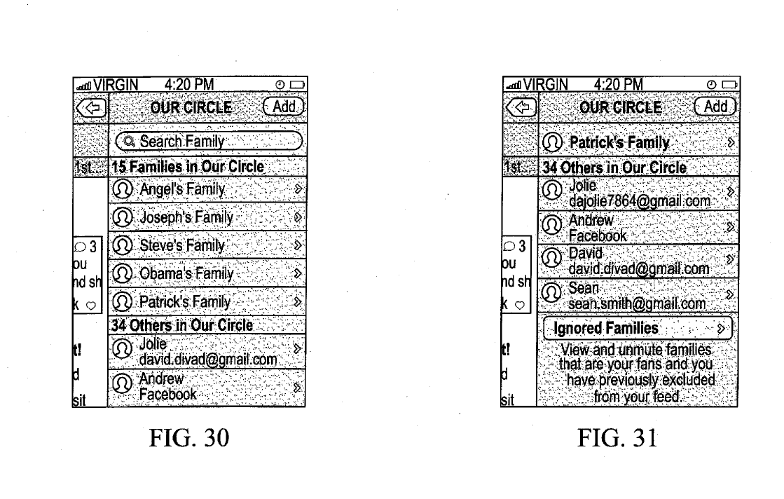

FIG. 30 shows an our circle screen providing user add button for adding families, under an embodiment.

FIG. 31 shows scrolled down portion of an our circle screen showing ignored families menu item, under an embodiment.

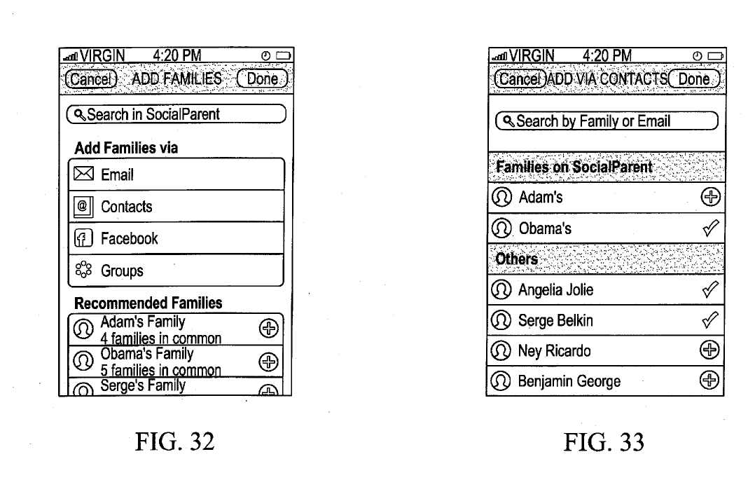

FIG. 32 shows an add family screen, under an embodiment.

FIG. 33 shows an add family via contacts screen, under an embodiment.

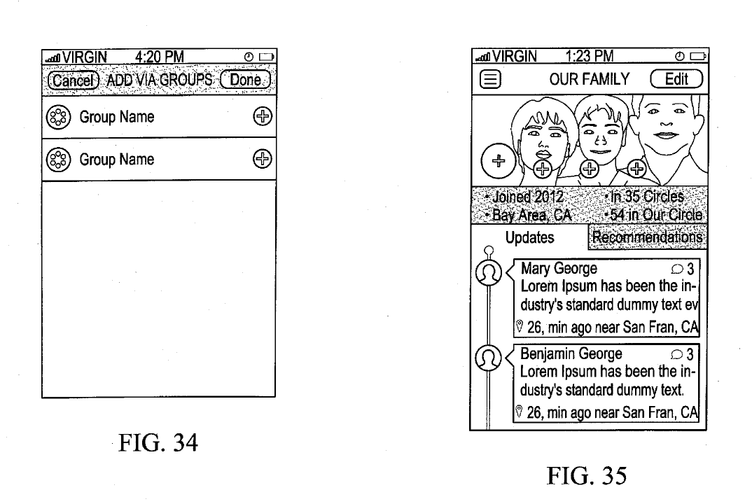

FIG. 34 shows an add family via groups screen, under an embodiment.

FIG. 35 shows privacy level, under an embodiment.

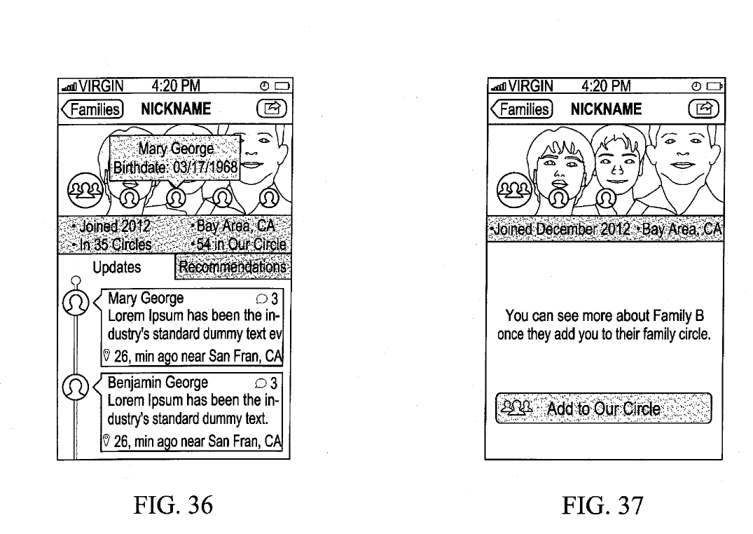

FIG. 36 shows privacy level, under an embodiment.

FIG. 37 shows privacy level, under an embodiment.

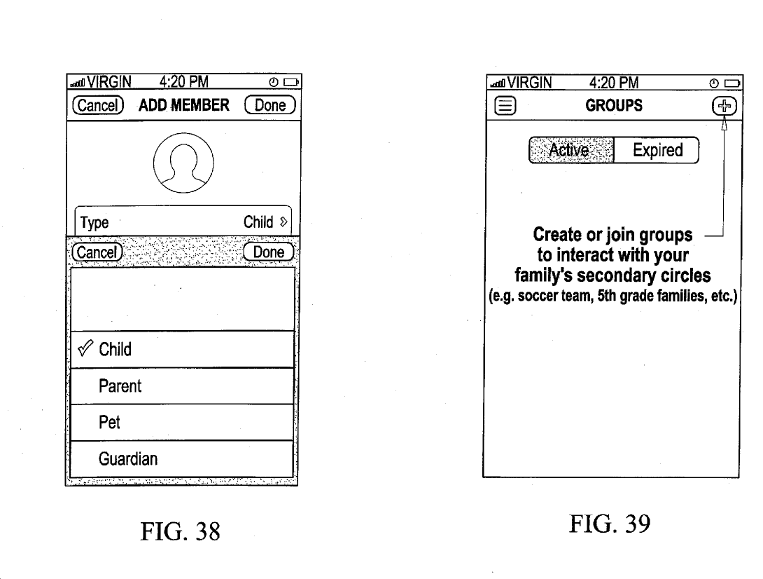

FIG. 38 shows an add member screen, under an embodiment.

FIG. 39 shows an application screen enabling user to create or join groups to interact with family secondary circles, under an embodiment.

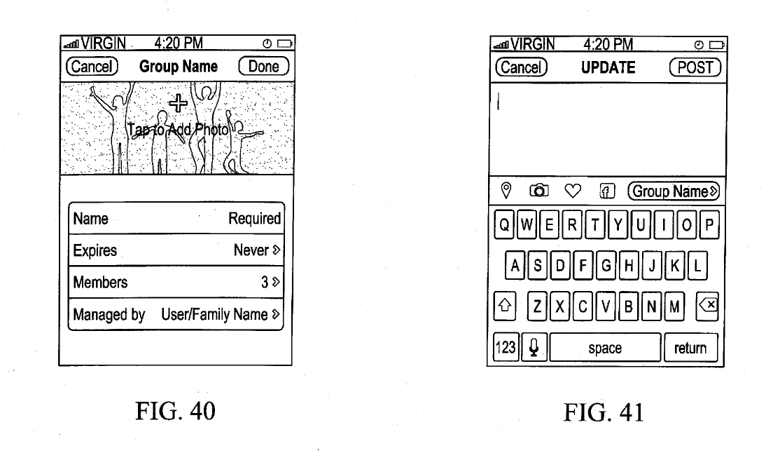

FIG. 40 shows a screen enabling user to input group name and data, under an embodiment.

FIG. 41 shows a screen enabling user to post messages, under an embodiment.

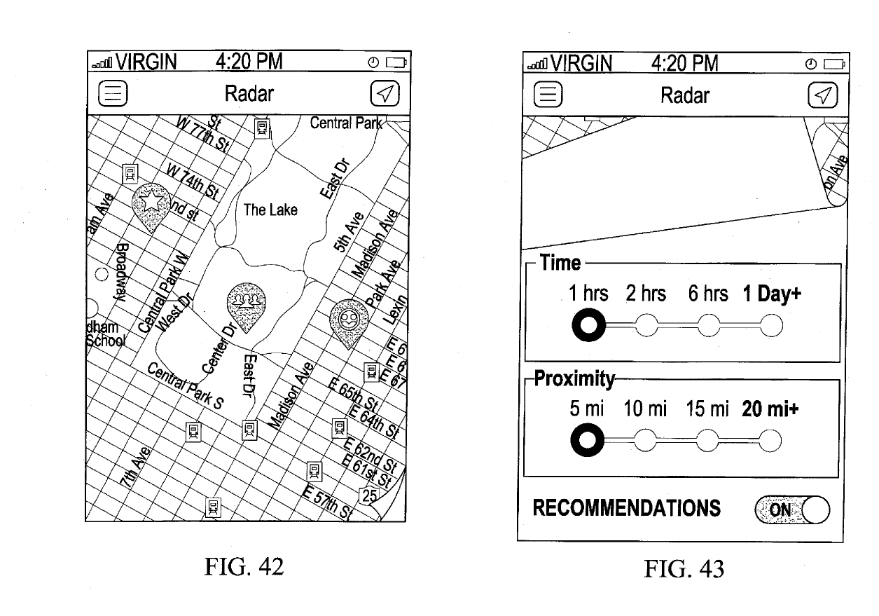

FIG. 42 is a screen demonstrating radar functionality of the SocialParent system, under an embodiment.

FIG. 43 shows an application screen showing radar filters, under an embodiment.

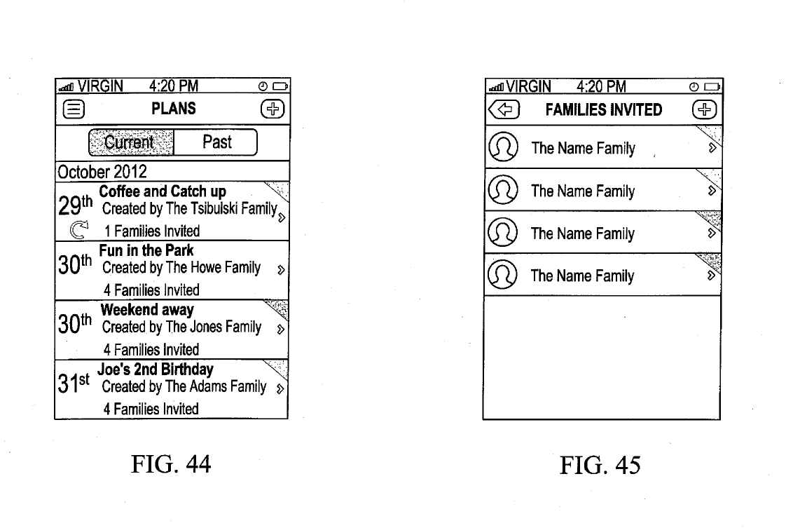

FIG. 44 is an application screen showing plans including families invited and enabling addition of plans.

FIG. 45 shows a families invited screen, under an embodiment.

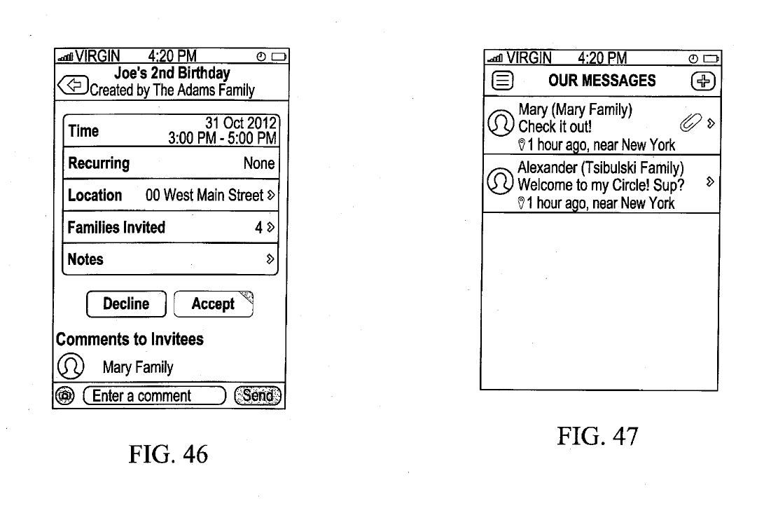

FIG. 46 shows an accepted invite view, under an embodiment.

FIG. 47 is an application view listing messages, under an embodiment.

Embodiments described herein include a system comprising a database that stores a plurality of interrelated family models that represent a plurality of families. Each family model of the plurality of interrelated family models includes family data that is aggregated data of a plurality of members of the family. The family data includes for each family member data of at least two of birthdate, gender, educational data, interests, team membership, religious organization membership, civic organization membership, and club membership. Each family is identified using a unique family identifier. Each family model comprises information that defines relationships between other family models based on the family data of the plurality of families. The system comprises a platform comprising a processor networked to the database and a social application executing on the processor. The platform receives a request to create the family model and in response collects the family data and generates the family model to include the family data. The platform enables the plurality of families to manage and interact using permanent groups, auto-expire groups, and affiliated groups, plan activities as part of a conversation thread, and receive recommendations based on the family data.

Embodiments described herein include a system comprising: a database that stores a plurality of interrelated family models that represent a plurality of families, wherein each family model of the plurality of interrelated family models includes family data that is aggregated data of a plurality of members of the family, wherein the family data includes for each family member data of at least two of birthdate, gender, educational data, interests, team membership, religious organization membership, civic organization membership, and club membership, wherein each family is identified using a unique family identifier, wherein each family model comprises information that defines relationships between other family models based on the family data of the plurality of families; and a platform comprising a processor networked to the database and a social application executing on the processor, wherein the platform receives a request to create the family model and in response collects the family data and generates the family model to include the family data, wherein the platform enables the plurality of families to manage and interact using permanent groups, auto-expire groups, and affiliated groups, plan activities as part of a conversation thread, and receive recommendations based on the family data.

A permanent group of an embodiment comprises a trusted set of families of the plurality of families, wherein families of the trusted set share a common collective set of attributes.

An auto-expire group of an embodiment includes an expiration date, wherein the auto-expire group automatically dissolves at the expiration date.

Membership in the auto-expire group of an embodiment is based on a temporary attribute.

The platform of an embodiment generates prompts to families in an expiring group to add other families from the expiring group to another group type.

An expired group of an embodiment is hidden from a groups list of which it is a member.

Expired groups of an embodiment can be at least one of restored by the platform and searched.

An affiliated group of an embodiment is permanent and at least one member of the affiliated group is outside a trusted set of families.

The platform of an embodiment enables the plurality of families to manage and interact using custom groups, wherein the custom groups are private to members of the custom group.

A first family adds a second family to a first group of an embodiment using a trusted unidirectional add model.

The second family is notified of being added to the first group of an embodiment.

The second family receives activity information of the first family of an embodiment.

The second family has an option to add the first family to a second group of an embodiment.

The first family removes the second family from the first group of an embodiment, wherein the removing is absent notification to the second family.

The second family mutes the first family to prevent receipt of the activity information of an embodiment.

A group of an embodiment includes at least one non-member, wherein a non-member is an unregistered family on the platform.

The family data of an embodiment includes a name of each family member.

In response to entering a name of a parent the platform of an embodiment generates login information for the parent and sends the login information to the parent.

The family data of an embodiment includes an electronic mail address of at least one family member.

The family data of an embodiment includes address data of each family member.

The family data of an embodiment includes medical data of at least one family member.

The interactions between the plurality of families of an embodiment includes sharing updates to family data.

The interactions between the plurality of families of an embodiment includes formulating plans between the plurality of families.

The interactions between the plurality of families of an embodiment include sharing recommendations.

The interactions between the plurality of families of an embodiment include sharing advice.

The platform of an embodiment enables the plurality of families to plan activities as part of a conversation thread by generating a plan icon and associating the plan icon with each conversation thread.

Selection of the plan icon of an embodiment generates an invitation corresponding to the conversation thread.

The invitation of an embodiment automatically includes as addressees participants in the conversation thread.

The invitation of an embodiment is supplemented with information added by a user.

The invitation of an embodiment includes the conversation thread.

The invitation of an embodiment includes an association with the conversation thread.

The platform of an embodiment enables the plurality of families to associate a conversation thread with a plan by generating a comment icon and associating the comment icon with the plan.

The recommendations of an embodiment are generated using correlations between the family data of the plurality of families.

The recommendations of an embodiment include recommendations to at least one of activities, books, music, toys, restaurants, and travel.

Embodiments described herein include a system comprising a database including a plurality of family models. Each family model includes family data that is aggregated data of a plurality of members of the family. The family data includes for each family member data of at least one of name, age, gender, education, interests, and memberships. Each family model comprises information that defines relationships between other families based on the family data. The system comprises a platform comprising a processor networked to the database and a social application executing on the processor. The platform receives a request to create the family model and in response collects the family data and generates the family model to include the family data. The platform enables the plurality of families to manage and interact using a plurality of group types.

Embodiments described herein include a system comprising: a database including a plurality of family models, wherein each family model includes family data that is aggregated data of a plurality of members of the family, wherein the family data includes for each family member data of at least one of name, age, gender, education, interests, and memberships, wherein each family model comprises information that defines relationships between other families based on the family data; and a platform comprising a processor networked to the database and a social application executing on the processor, wherein the platform receives a request to create the family model and in response collects the family data and generates the family model to include the family data, wherein the platform enables the plurality of families to manage and interact using a plurality of group types.

Embodiments described herein include a method comprising receiving at a platform a request to create a plurality of family models corresponding to a plurality of families. The method comprises collecting family data of each family of the plurality of families in response to the request. The family data includes aggregated data of a plurality of members of each family. The family data includes for each family member data of at least two of birthdate, gender, educational data, interests, team membership, religious organization membership, civic organization membership, and club membership. The method comprises generating a unique family identifier corresponding to each family. The method comprises generating a family model for each family to include the family data and the family identifier. The method comprises generating interrelationships between the plurality of family models based on the family data of the plurality of families. The method comprises managing relationships and interactions between the plurality of families in response to inputs received at the platform. The managing includes managing permanent, auto-expire, and affiliated groups of families. The managing includes planning activities as part of a conversation thread. The managing includes receiving recommendations based on the family data.

Embodiments described herein include a method comprising: receiving at a platform a request to create a plurality of family models corresponding to a plurality of families; collecting family data of each family of the plurality of families in response to the request, wherein the family data includes aggregated data of a plurality of members of each family, wherein the family data includes for each family member data of at least two of birthdate, gender, educational data, interests, team membership, religious organization membership, civic organization membership, and club membership; generating a unique family identifier corresponding to each family; generating a family model for each family to include the family data and the family identifier; generating interrelationships between the plurality of family models based on the family data of the plurality of families; and managing relationships and interactions between the plurality of families in response to inputs received at the platform, the managing including managing permanent, auto-expire, and affiliated groups of families, the managing including planning activities as part of a conversation thread, the managing including receiving recommendations based on the family data.

The method of an embodiment comprises generating a permanent group to include a trusted set of families of the plurality of families, wherein families of the trusted set share a common collective set of attributes.

The method of an embodiment comprises generating an auto-expire group to include an expiration date, wherein the auto-expire group automatically dissolves at the expiration date.

The method of an embodiment comprises basing membership in the auto-expire group on a temporary attribute.

The method of an embodiment comprises generating prompts to families in an expiring group to add other families from the expiring group to another group type.

The method of an embodiment comprises hiding an expired group from a groups list of which it is a member.

The method of an embodiment comprises restoring an expired group.

The method of an embodiment comprises searching contents of an expired group.

An affiliated group of an embodiment is permanent and at least one member of the affiliated group is outside a trusted set of families.

The method of an embodiment comprises enabling the plurality of families to manage and interact using custom groups, wherein the custom groups are private to members of the custom group.

The method of an embodiment comprises a trusted unidirectional model by which a first family adds a second family to a first group.

The method of an embodiment comprises notifying the second family of being added to the first group.

The method of an embodiment comprises providing to the second family activity information of the first family.

The method of an embodiment comprises providing the second family with an option to add the first family to a second group.

The method of an embodiment comprises the first family removing the second family from the first group, wherein the removing is absent notification to the second family.

The method of an embodiment comprises the second family muting the first family to prevent receipt of the activity information.

A group of an embodiment includes at least one non-member, wherein a non-member is an unregistered family on the platform.

The family data of an embodiment includes a name of each family member.

The method of an embodiment comprises generating login information for a parent and sending the login information to the parent in response to entering a name of the parent.

The family data of an embodiment includes an electronic mail address of at least one family member.

The family data of an embodiment includes address data of each family member.

The family data of an embodiment includes medical data of at least one family member.

The interactions between the plurality of families of an embodiment include sharing updates to family data.

The interactions between the plurality of families of an embodiment includes formulating plans between the plurality of families.

The interactions between the plurality of families of an embodiment includes sharing recommendations.

The interactions between the plurality of families of an embodiment include sharing advice.

The method of an embodiment comprises enabling the plurality of families to plan activities as part of a conversation thread by generating a plan icon and associating the plan icon with each conversation thread.

Selection of the plan icon of an embodiment generates an invitation corresponding to the conversation thread.

The method of an embodiment comprises automatically including participants in the conversation thread as addressees on an invitation.

The method of an embodiment comprises supplementing the invitation with information added by a user.

The invitation of an embodiment includes the conversation thread.

The invitation of an embodiment includes an association with the conversation thread.

The method of an embodiment comprises enabling the plurality of families to associate a conversation thread with a plan by generating a comment icon and associating the comment icon with the plan.

The method of an embodiment comprises generating the recommendations using correlations between the family data of the plurality of families.

The recommendations of an embodiment include recommendations to at least one of activities, books, music, toys, restaurants, and travel.

Embodiments described herein include a method comprising receiving at a platform a request to create a plurality of family models corresponding to a plurality of families. The method comprises collecting family data of each family of the plurality of families. The family data includes aggregated data of a plurality of members of each family. The family data includes for each family member data of at least one of name, age, gender, education, interests, and memberships. The method comprises generating a family model for each family to include the family data and a unique family identifier. The method comprises managing relationships and interactions between the plurality of families according to a plurality of group types of which the plurality of families are members.

Embodiments described herein include a method comprising: receiving at a platform a request to create a plurality of family models corresponding to a plurality of families; collecting family data of each family of the plurality of families, wherein the family data includes aggregated data of a plurality of members of each family, wherein the family data includes for each family member data of at least one of name, age, gender, education, interests, and memberships; generating a family model for each family to include the family data and a unique family identifier; and managing relationships and interactions between the plurality of families according to a plurality of group types of which the plurality of families are members.

Computer systems and networks suitable for use with the SocialParent embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network as a component of SocialParent may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The SocialParent system can be a component of a single system, multiple systems, and/or geographically separate systems. The SocialParent system can also be a subcomponent or subsystem of a single system, multiple systems, and/or geographically separate systems. The SocialParent system can be coupled to one or more other components (not shown) of a host system or a system coupled to the host system.

One or more components of the SocialParent system and/or a corresponding system or application to which the SocialParent system is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes the SocialParent system can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the SocialParent system and corresponding systems and methods is not intended to be exhaustive or to limit the systems and methods to the precise forms disclosed. While specific embodiments of, and examples for, the SocialParent system and corresponding systems and methods are described herein for illustrative purposes, various equivalent modifications are possible within the scope of the systems and methods, as those skilled in the relevant art will recognize. The teachings of the SocialParent system and corresponding systems and methods provided herein can be applied to other systems and methods, not only for the systems and methods described above. The elements and acts of the various embodiments described above can be combined to provide further embodiments. These and other changes can be made to the SocialParent system and corresponding systems and methods in light of the above detailed description.

What is claimed is:

1. A system comprising:
a database that stores a plurality of interrelated family models that represent a plurality of families, wherein each family model of the plurality of interrelated family models includes family data that is aggregated data of a plurality of members of the family, wherein the family data includes for each family member data of at least two of birthdate, gender, educational data, interests, team membership, religious organization membership, civic organization membership, and club membership, wherein each family is identified using a unique family identifier, wherein each family model comprises information that defines relationships between other family models based on the family data of the plurality of families; and
a platform comprising a processor networked to the database and a social application executing on the processor, wherein the platform receives a request to create the family model and in response collects the family data and generates the family model to include the family data, wherein the platform enables the plurality of families to manage and interact using permanent groups, auto-expire groups, and affiliated groups, plan activities as part of a conversation thread, and receive recommendations based on the family data.

2. The system of claim 1, wherein a permanent group comprises a trusted set of families of the plurality of families, wherein families of the trusted set share a common collective set of attributes.

3. The system of claim 1, wherein an auto-expire group includes an expiration date, wherein the auto-expire group automatically dissolves at the expiration date.

4. The system of claim 3, wherein membership in the auto-expire group is based on a temporary attribute.

5. The system of claim 3, wherein the platform generates prompts to families in an expiring group to add other families from the expiring group to another group type.

6. The system of claim 3, wherein an expired group is hidden from a groups list of which it is a member.

7. The system of claim 6, wherein expired groups can be at least one of restored by the platform and searched.

8. The system of claim 1, wherein an affiliated group is permanent and at least one member of the affiliated group is outside a trusted set of families.

9. The system of claim 1, wherein the platform enables the plurality of families to manage and interact using custom groups, wherein the custom groups are private to members of the custom group.

10. The system of claim 1, wherein a first family adds a second family to a first group using a trusted unidirectional add model.

11. The system of claim 10, wherein the second family is notified of being added to the first group.

12. The system of claim 11, wherein the second family receives activity information of the first family.

13. The system of claim 12, wherein the second family has an option to add the first family to a second group.

14. The system of claim 12, wherein the first family removes the second family from the first group, wherein the removing is absent notification to the second family.

15. The system of claim 12, wherein the second family mutes the first family to prevent receipt of the activity information.

16. The system of claim 1, wherein a group includes at least one non-member, wherein a non-member is an unregistered family on the platform.

17. The system of claim 1, wherein the family data includes a name of each family member.

18. The system of claim 17, wherein in response to entering a name of a parent the platform generates login information for the parent and sends the login information to the parent.

19. The system of claim 1, wherein the family data includes an electronic mail address of at least one family member.

20. The system of claim 1, wherein the family data includes address data of each family member.

21. The system of claim 1, wherein the family data includes medical data of at least one family member.

22. The system of claim 1, wherein the interactions between the plurality of families includes sharing updates to family data.

23. The system of claim 1, wherein the interactions between the plurality of families includes formulating plans between the plurality of families.

24. The system of claim 1, wherein the interactions between the plurality of families include sharing recommendations.

25. The system of claim 1, wherein the interactions between the plurality of families include sharing advice.

26. The system of claim 1, wherein the platform enables the plurality of families to plan activities as part of a conversation thread by generating a plan icon and associating the plan icon with each conversation thread.

27. The system of claim 26, wherein selection of the plan icon generates an invitation corresponding to the conversation thread.

28. The system of claim 27, wherein the invitation automatically includes as addressees participants in the conversation thread.

29. The system of claim 28, wherein the invitation is supplemented with information added by a user.

30. The system of claim 29, wherein the invitation includes the conversation thread.

31. The system of claim 29, wherein the invitation includes an association with the conversation thread.

32. The system of claim 1, wherein the platform enables the plurality of families to associate a conversation thread with a plan by generating a comment icon and associating the comment icon with the plan.

33. The system of claim 1, wherein the recommendations are generated using correlations between the family data of the plurality of families.

34. The system of claim 1, wherein the recommendations include recommendations to at least one of activities, books, music, toys, restaurants, and travel.

35. A system comprising:
a database including a plurality of family models, wherein each family model includes family data that is aggregated data of a plurality of members of the family, wherein the family data includes for each family member data of at least one of name, age, gender, education, interests, and memberships, wherein each family model comprises information that defines relationships between other families based on the family data; and
a platform comprising a processor networked to the database and a social application executing on the processor, wherein the platform receives a request to create the family model and in response collects the family data and generates the family model to include the family data, wherein the platform enables the plurality of families to manage and interact using a plurality of group types.

36. A method comprising:
receiving at a platform a request to create a plurality of family models corresponding to a plurality of families;
collecting family data of each family of the plurality of families in response to the request, wherein the family data includes aggregated data of a plurality of members of each family, wherein the family data includes for each family member data of at least two of birthdate, gender, educational data, interests, team membership, religious organization membership, civic organization membership, and club membership;
generating a unique family identifier corresponding to each family;
generating a family model for each family to include the family data and the family identifier;
generating interrelationships between the plurality of family models based on the family data of the plurality of families; and
managing relationships and interactions between the plurality of families in response to inputs received at the platform, the managing including managing permanent, auto-expire, and affiliated groups of families, the managing including planning activities as part of a conversation thread, the managing including receiving recommendations based on the family data.

37. The method of claim 36, comprising generating a permanent group to include a trusted set of families of the plurality of families, wherein families of the trusted set share a common collective set of attributes.

38. The method of claim 36, comprising generating an auto-expire group to include an expiration date, wherein the auto-expire group automatically dissolves at the expiration date.

39. The method of claim 38, comprising basing membership in the auto-expire group on a temporary attribute.

40. The method of claim 38, comprising generating prompts to families in an expiring group to add other families from the expiring group to another group type.

41. The method of claim 38, comprising hiding an expired group from a groups list of which it is a member.

42. The method of claim 41, comprising restoring an expired group.

43. The method of claim 41, comprising searching contents of an expired group.

44. The method of claim 36, wherein an affiliated group is permanent and at least one member of the affiliated group is outside a trusted set of families.

45. The method of claim 36, comprising enabling the plurality of families to manage and interact using custom groups, wherein the custom groups are private to members of the custom group.

46. The method of claim 36, comprising a trusted unidirectional model by which a first family adds a second family to a first group.

47. The method of claim 46, comprising notifying the second family of being added to the first group.

48. The method of claim 47, comprising providing to the second family activity information of the first family.

49. The method of claim 48, comprising providing the second family with an option to add the first family to a second group.

50. The method of claim 48, comprising the first family removing the second family from the first group, wherein the removing is absent notification to the second family.

51. The method of claim 48, comprising the second family muting the first family to prevent receipt of the activity information.

52. The method of claim 36, wherein a group includes at least one non-member, wherein a non-member is an unregistered family on the platform.

53. The method of claim 36, wherein the family data includes a name of each family member.

54. The method of claim 53, comprising generating login information for a parent and sending the login information to the parent in response to entering a name of the parent.

55. The method of claim 36, wherein the family data includes an electronic mail address of at least one family member.

56. The method of claim 36, wherein the family data includes address data of each family member.

57. The method of claim 36, wherein the family data includes medical data of at least one family member.

58. The method of claim 36, wherein the interactions between the plurality of families include sharing updates to family data.

59. The method of claim 36, wherein the interactions between the plurality of families includes formulating plans between the plurality of families.

60. The method of claim 36, wherein the interactions between the plurality of families includes sharing recommendations.

61. The method of claim 36, wherein the interactions between the plurality of families include sharing advice.

62. The method of claim 36, comprising enabling the plurality of families to plan activities as part of a conversation thread by generating a plan icon and associating the plan icon with each conversation thread.

63. The method of claim 62, wherein selection of the plan icon generates an invitation corresponding to the conversation thread.

64. The method of claim 63, comprising automatically including as addressees to an invitation participants in the conversation thread.

65. The method of claim 64, comprising supplementing the invitation with information added by a user.

66. The method of claim 65, wherein the invitation includes the conversation thread.

67. The method of claim 65, wherein the invitation includes an association with the conversation thread.

68. The method of claim 36, comprising enabling the plurality of families to associate a conversation thread with a plan by generating a comment icon and associating the comment icon with the plan.

69. The method of claim 36, comprising generating the recommendations using correlations between the family data of the plurality of families.

70. The method of claim 36, wherein the recommendations include recommendations to at least one of activities, books, music, toys, restaurants, and travel.

71. A method comprising:
receiving at a platform a request to create a plurality of family models corresponding to a plurality of families;
collecting family data of each family of the plurality of families, wherein the family data includes aggregated data of a plurality of members of each family, wherein the family data includes for each family member data of at least one of name, age, gender, education, interests, and memberships;
generating a family model for each family to include the family data and a unique family identifier; and
managing relationships and interactions between the plurality of families according to a plurality of group types of which the plurality of families are members.
